(19) United States
(12) Patent Application Publication
(10) Pub. No.: US 2024/0266768 A1
(43) Pub. Date: Aug. 8, 2024

(54) SELF-ALIGNING BOARD-TO-BOARD CONNECTORS

(71) Applicant: Apple Inc., Cupertino, CA (US)

(72) Inventors: Jason S. Sloey, Cedar Park, TX (US); George Tziviskos, San Jose, CA (US); Aaron N. Miletich, San Jose, CA (US); Daren L. Rimando, Milpitas, CA (US); Mahmoud R. Amini, Redwood City, CA (US); Logan T. Fikrig, San Francisco, CA (US); Ross L. Jackson, San Francisco, CA (US); Mohammed Nasser Khamis Al Jashmi, New Taipei City (TW)

(73) Assignee: Apple Inc., Cupertino, CA (US)

(21) Appl. No.: 18/434,575

(22) Filed: Feb. 6, 2024

Related U.S. Application Data
(60) Provisional application No. 63/443,672, filed on Feb. 6, 2023.

(51) Int. Cl. H01R 12/79; H01R 13/512; H01R 13/629; H01R 13/6581

(52) U.S. Cl. CPC H01R 12/79; H01R 13/512; H01R 13/629; H01R 13/6581

(57) ABSTRACT

Board-to-board connectors that can provide blind mating, are easily included in an electronic device, and are readily manufactured. An example can provide a self-aligning board-to-board connector that provides blind mating and that includes a first connector and a second connector. The first connector can include a first fastener fixed to a first internal housing or enclosure portion. A second fastener can be mated with the first fastener. The first connector can further include a housing, where the housing is flexibly connected to the first internal housing or enclosure portion but is constrained by the first fastener and the second fastener. This constraint can allow the first connector housing to move laterally and rotationally such that it can self-align to a second connector that is fixed to a second internal housing or enclosure portion when the first connector and second connector are mated. A flexible circuit board can connect contacts of the first connector to a board or other structure that is fixed to the first internal housing or enclosure portion. The flexible circuit board can maintain this connection as the first connector housing is moved laterally or rotationally during device assembly.

### CROSS-REFERENCES TO RELATED APPLICATIONS

The present application claims the benefit of and priority to U.S. provisional application 63/443,672, filed Feb. 6, 2023, which is incorporated by reference.

### BACKGROUND

The number of types of electronic devices that are commercially available has increased tremendously the past few years and the rate of introduction of new devices shows no signs of abating. Devices such as tablet, laptop, desktop, and all-in-one computers, cell phones, storage devices, wearable-computing devices, portable media players, navigation systems, monitors, audio devices, adapters, and others, have become ubiquitous.

These devices can be housed in an enclosure that can include or be supported by multiple portions, such as a lid, a bottom, a frame, or other internal housing or enclosure portions, where one or more portions can be functional devices, such as a display or screen. During assembly, the enclosure can be sealed or closed, for example by securing a lid or bottom to a frame, internal housing, or other enclosure portion.

Two or more components connected or fixed to these enclosure or housing portions, such as a printed circuit board, flexible circuit board, or other component, can be connected using wires, flexible circuit boards or other flexible conduits. During assembly, the wires or flexible circuit boards can be positioned to fit within the enclosure as the enclosure is sealed. This can allow a connection between two enclosure portions that would otherwise be extremely difficult or impossible to form once the device enclosure is closed or sealed.

But this process can be somewhat unreliable. For example, wires can get pinched between the two housing or enclosure portions, a flexible circuit board can be damaged by an application of excessive force, or other damage can occur during enclosure sealing. Also, the excess lengths of wires, flexible circuit boards, or other flexible conduits can waste space inside the electronic device.

Accordingly, it can be desirable to provide efficient connections when two enclosure portions are mated. The act of forming such a connection can be referred to as blind mating since the connection can be difficult or impossible to access or view during and after the mating of the housing or enclosure portions.

These connections can be difficult to implement in a high volume assembly process. Also, some of these electronic devices can be manufactured in high volumes. To meet demand for these products, it can be desirable that these connections are easily included in an electronic device and be readily manufactured.

Thus, what is needed are components that can form connections during blind mating, are easily included in an electronic device, and can be readily manufactured.

### SUMMARY

Accordingly, embodiments of the present invention can provide components that can form connections during blind mating, can be easily included in an electronic device, and can be readily manufactured. An illustrative embodiment of the present invention can provide a self-aligning board-to-board connector that provides blind mating and that includes a first connector and a second connector. The first connector can include a first fastener fixed to a first internal housing or enclosure portion. A second fastener can be mated with the first fastener. The first connector can further include a housing, where the housing is flexibly, not rigidly, connected to the first internal housing or enclosure portion and is constrained in its movements by the first fastener and the second fastener. This constraint can allow the first connector housing to move laterally or rotationally (angularly) such that it can self-align to a second connector that is fixed to a second internal housing or enclosure portion when the first connector and second connector are mated. A flexible circuit board can connect contacts of the first connector to a board or other structure that is fixed to the first internal housing or enclosure portion. The flexible circuit board can maintain this connection as the first connector housing is moved laterally or rotationally during device assembly.

The second connector housing can support a number of contacts that can form electrical connections with the contacts of the first connector. The contacts of the first and second connector can include signal contacts, power contacts, and other types of contacts. The power contacts can typically be wider than signal contacts to support the higher currents associated with power supplies. The first connector and the second connector can each include a shield that connect to each other and are grounded. The shields can be over a portion of the housings of each of the first and second connectors. The housing portions and shields can include chamfered edges that guide the housing of the first connector into position to form a connection with the second connector. The movement or displacement of the housing of the first connector can be absorbed by the flexible circuit board connecting the contacts of the first connector to the first internal housing or enclosure portion.

The movement of the first connector housing can be constrained by the first fastener and the second fastener. For example, first connector housing can include an opening where the first fastener fits into the opening such that the first connector housing is laterally and rotationally constrained by the first fastener. The first fastener can be a shoulder screw or other type of fastener. A second fastener can be fit into the first fastener. The second fastener can be a screw or other fastener and can include a widened top such that the housing of the first connector is vertically constrained by the widened top of the second fastener. The first connector can include a threaded opening into which a threaded second fastener can be inserted. The widened top of the second fastener can include an impression that accepts a screwdriver or other tool for screwing the second fastener into the first fastener. Alternatively, the second fastener can be press-fit into the first connector, or other type of fastener mating can be used. The first fastener can be fixed to a printed circuit board or other appropriate substrate, an internal housing or enclosure portion, for example by soldering. Alternatively, the second fastener can be fit through the first fastener and threaded into the internal housing or enclosure portion, or the second fastener can fit through the first fastener, the internal housing or enclosure portion, and be secured using a bolt or other third fastener behind the internal housing or enclosure portion.

Alternatively, a single fastener having a widened top can be used to constrain the motion of the housing of the first connector. The single fastener can be soldered to, threaded into, or held in place by a bolt or other fastener to a printed circuit board or other appropriate substrate, or the internal housing or enclosure portion.

In these and other embodiments of the present invention, a first connector housing can include two openings, and one or two fasteners can be used in conjunction with each opening. In these and other embodiments of the present invention, a first connector can include three or more openings and corresponding one, two, or more fasteners.

These and other embodiments of the present invention can provide board-to-board connectors that include alignment features. These alignment features can be used to improve the mating of a first connector and a second connector of the board-to-board connector. An illustrative embodiment of the present invention can include one or more posts, pillars, or other alignment features. These alignment features can extend from a housing of the first connector or they can be mounted on or otherwise attached to the housing or other portion of the first connector. The one or more alignment features can fit in corresponding openings in a second connector. These openings can be in a housing in the second connector. The alignment features can be arranged to align the first connector to the second connector before contacts of the first connector engage contacts of the second connector. The alignment features can be flush or sub-flush with a bottom surface of the second connector when the first connector and the second connector are mated. The alignment features can extend beyond the bottom of the second connector and can fit into openings or recesses in a board or other substrate on which the second connector is mounted.

These alignment features, such as posts and openings, can have various shapes. For example, they can have a circular cross-section. The can instead have a “D” shape, “+” shape, or other shaped cross-section. Such a non-circular shape can be used as a keying feature to prevent a mis-mating of a first and second connector.

These and other embodiments of the present invention can provide board-to-board connectors that can be fastened together to provide a reliable connection. This can be helpful where connectors can be dropped or otherwise experience a physical shock, prolonged vibration, or other force or forces that could otherwise cause the first connector to become disconnected from the second connector.

An illustrative embodiment of the present invention can include a locking feature. This locking feature can be used separately or in conjunction with one, two, or more than two other alignment features. The locking feature can include an insert extending from a body of the first connector. The insert can be formed as part of or separately from the housing of the first connector. The insert can be formed of metal or other material. The insert can be threaded and can fit in a threaded opening in the second connector. A fastener, such as a screw, can be threaded into the insert to secure the first board to the second board, or to secure the first board and the second board to a printed circuit board or other appropriate substrate. The insert can be flush or sub-flush with a bottom surface of the second connector when the first connector and the second connector are mated. The insert can extend beyond the bottom surface of the second connector and fit into an opening in a board or other substrate on which the second connector is mounted.

These and other embodiments of the present invention employ other alignment features. For example, a slot in a housing of a first connector can accept a tab protruding from a housing or a shield of a second connector. An arc-shaped opening in a housing of a first connector can accept an arc-shaped protrusion formed by either or both the housing and shield of a second connector. A D-shaped opening in a housing of a first connector can accept a D-shaped protrusion formed by either or both the housing and shield of a second connector. An extended portion of a first connector can fit in a guide formed by either or both of the housing and shield of a second connector.

These and other board-to-board connectors provided by embodiments of the present invention can include features that can reduce damage that could otherwise be caused by angular disengagements between connectors. For example, recessed portion of a housing around an opening can be protected by a portion of a shield. The area around the opening can be tapered to allow an alignment post on a second connector to be inserted and extracted from the opening with a reduced chance of damage. The alignment post can also be tapered to help avoid damage. Interfacing portions of housings for either or both connectors can be tapered or chamfered to avoid damage.

An illustrative embodiment of the present invention can provide a board-to-board connector system. The board-to-board connector system can include a first board comprising a first opening and a second board comprising a first opening. A first fastener can include a first head and a first shaft, where the first shaft passes through the first opening in the first board and the first opening in the second board. The board-to-board connector system can include a first plurality of contacts on a bottom side of the first board and below the first head; and a second plurality of contacts on a top side of the second board and below the first head. The second plurality of contacts can be positioned to mate with the first plurality of contacts.

In these and other embodiments of the present invention, the first connector can be one of a receptacle or a plug. The second connector can be one of a receptacle or a plug.

These and other embodiments of the present invention can provide board-to-board connectors that are easy to use and connect in an electronic device. This can facilitate and simplify assembly. These features can also facilitate device repair and component replacement by users and other third party.

While embodiments of the present invention can provide a first connector that connects to an internal housing or enclosure portion through a circuit board, these and other embodiments of the present invention can provide a connection to a printed circuit board or other conduit structure that is attached to or otherwise fixed or associated with the internal housing or enclosure portion.

While these and other embodiments of the present invention are well-suited for use in connecting two or more internal housing or enclosure portions together, embodiments of the present invention can provide board-to-board connectors for non-blind connections, or blind connections between other structures, such as printed circuit boards or flexible circuit boards that are not fixed to an internal housing or enclosure portion.

In these and other embodiments of the present invention, signal contacts, power supply contacts, ground contacts, ground shields, and other conductive portions can be formed by stamping, metal-injection molding, forging, deep drawing, machining, micro-machining, 3-D printing, or other manufacturing process. The conductive portions can be formed of stainless steel, steel, copper, copper titanium, phosphor bronze, or other material or combination of materials. They can be plated or coated with nickel, gold, or other material. The nonconductive portions, such as the internal housing and enclosure portions, can be formed using injection or other molding, 3-D printing, machining, or other manufacturing process. The nonconductive portions can be formed of silicon or silicone, rubber, hard rubber, plastic, nylon, glass-filled nylon, liquid-crystal polymers (LCPs), or other nonconductive material or combination of materials.

These and other embodiments of the present invention can provide board-to-board connectors that can be located in various types of devices, such as portable computing devices, tablet computers, desktop computers, laptops, all-in-one computers, cell phones, wearable-computing devices, storage devices, portable media players, navigation systems, monitors, power supplies, adapters, remote control devices, audio devices, chargers, and other devices. These board-to-board connectors can provide pathways for signals that are compliant with various standards such as Universal Serial Bus (USB), USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates a cross-section of a portion of an electronic device according to an embodiment of the present invention;

FIG. 2 is top view of a board-to-board connector according to an embodiment of the present invention;

FIG. 3 is a top view of a board-to-board connector according to an embodiment of the present invention;

FIG. 4 is a cutaway side view of the board-to-board connector of FIG. 2 and FIG. 3;

FIG. 5 is an assembled view of the board-to board connector shown in cutaway side view in FIG. 4;

FIG. 6 illustrates a top view of a first connector of a board-to-board connector according to an embodiment of the present invention;

FIG. 7 illustrates a top view of a second connector of a board-to-board connector according to an embodiment of the present invention;

FIG. 8 illustrates an oblique bottom view of the first connector shown in FIG. 6 mated with the second connector shown in FIG. 7;

FIG. 9 illustrates a cutaway side view of the mated board-to-board connector of FIG. 8;

FIG. 10 illustrates a portion of a board-to-board connector according to an embodiment of the present invention;

FIG. 11 illustrates a portion of a board-to-board connector according to an embodiment of the present invention;

FIG. 12 illustrates a portion of a board-to-board connector according to an embodiment of the present invention; and

FIG. 13 illustrates a portion of a board-to-board connector according to an embodiment of the present invention;

FIG. 14 illustrates a top view of a first connector for a board-to-board connector according to an embodiment of the present invention;

FIG. 15 illustrates a bottom view of the first connector shown in FIG. 14;

FIG. 16 illustrates a top view of a second connector for a board-to-board connector according to an embodiment of the present invention;

FIG. 17 illustrates a bottom view of the second connector of FIG. 16;

FIG. 18 illustrates top and bottom views of a first connector for a board-to-board connector according to an embodiment of the present invention;

FIG. 19 illustrates an exploded view of the first connector shown in FIG. 18;

FIG. 20 illustrates top and bottom views of a second connector for a board-to-board connector according to an embodiment of the present invention;

FIG. 21 illustrates an exploded view of the second connector shown in FIG. 20;

FIG. 22 illustrates a top view of a board-to-board connector according to an embodiment of the present invention; and

FIG. 23 illustrates a cutaway side view of the board-to-board connector of FIG. 22.

### DESCRIPTION OF ILLUSTRATIVE EMBODIMENTS

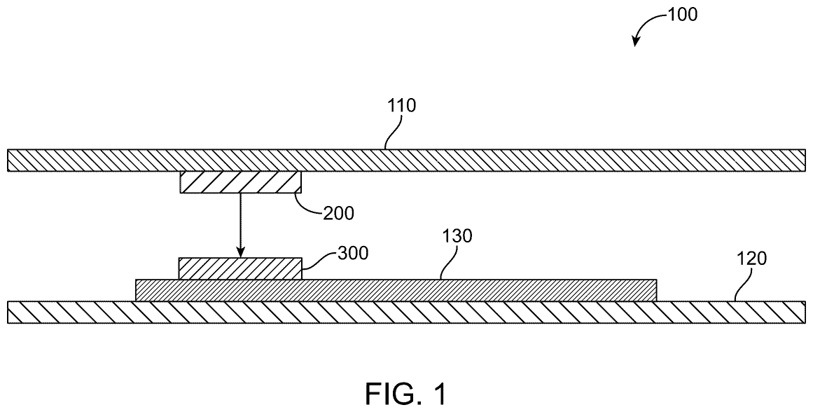

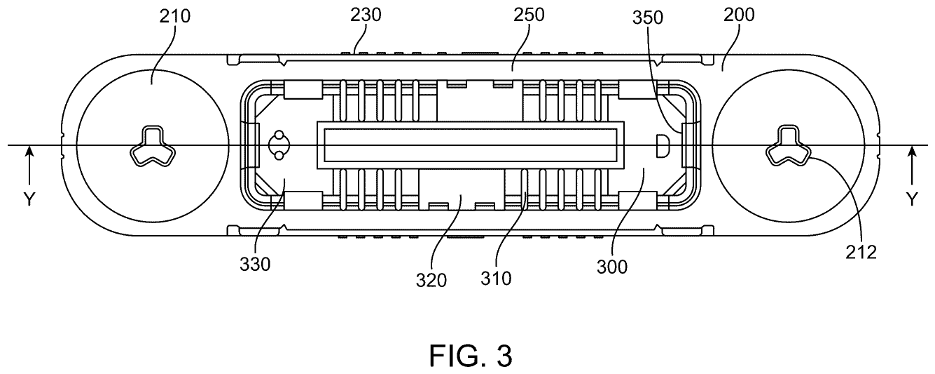

FIG. 1 illustrates a cross-section of a portion of an electronic device according to an embodiment of the present invention. In this example, an enclosure or portion of an enclosure for electronic device 100 is being sealed. First internal housing or enclosure portion 110 can be a lid, bottom, support, housing portion, screen or display, or other portion of an electronic device. First connector 200 and second connector 300 can be mated to form electrical pathways between first internal housing or enclosure portion 110 and main logic board 130. For example, first connector 200 and second connector 300 can be mated such that contacts (not shown) on the first connector 200 mate with signal contacts 310 and power contacts 320 (shown in FIG. 3) on the second connector 300 to form electrical pathways between components that make up or are included on or as part of first internal housing or enclosure portion 110 and main logic board 130. Main logic board 130 can be supported by second internal housing or enclosure portion 120. Second internal housing or enclosure portion 120 can be a lid, bottom, support, housing portion, screen or display, or other portion of an electronic device.

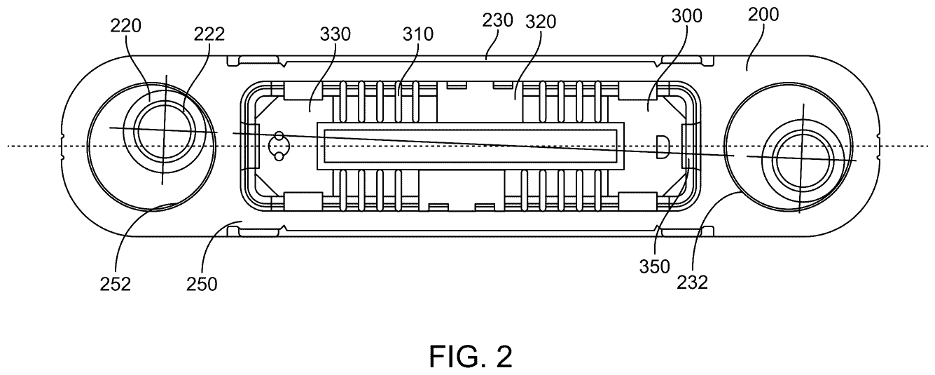

During assembly, first internal housing or enclosure portion 110 can be connected to main logic board 130 through a board-to-board connector including first connector 200 and second connector 300. But it can be very difficult or impossible for an assembly operator to properly align first connector 200 with second connector 300. Accordingly, either or both first connector 200 and second connector 300 can include self-alignment capabilities. For example, first connector 200 can include a first fastener 220 (shown in FIG. 2) attached to first internal housing or enclosure portion 110. A housing 230 of first connector 200 can be free to laterally and rotationally move relative to first internal housing or enclosure portion 110, though this movement can be constrained by first fastener 220. Contacts of first connector 200 can be electrically connected to conductors of or associated with first internal housing or enclosure portion 110 through flexible circuit board 150 (shown in FIG. 3.) Flexible circuit board 150 can absorb the movement that can be necessary to compensate for misalignment of first connector 200 to second connector 300. A second fastener 210 (shown in FIG. 3) can be used in conjunction with first fastener 220. Second fastener 210 can limit vertical movement of the housing 230 of first connector 200 during assembly. A pair of first fasteners 220 and second fasteners 210 can be included, with one each of first fasteners 220 and second fasteners 210 in an opening 252 near at a first end of housing 230 and an opening 232 near a second end of housing 230. An example is shown in the following figures.

FIG. 2 is top view of a board-to-board connector according to an embodiment of the present invention. First connector 200 can be a receptacle having a housing 230 partially shielded by shield 250. Housing 230 and shield 250 can include opening 232 and opening 252 near each end. First connector 200 can further include first fasteners 220 in each opening 252. First fasteners 220 can include threaded inside surfaces 222. First fasteners 220 can constrain the movement of housing 230 of first connector 200 and can allow housing 230 of first connector 200 to laterally and rotationally move such that housing 230 of first connector 200 can mate with second connector 300. Second connector 300 can be a plug that can include housing 330 supporting signal contacts 310 and power contacts 320. Second connector 300 can further include shielding 350. Shielding 350 can electrically connect to shielding 250 of first connector 200 when first connector 200 is mated with second connector 300.

In this example, housing 230 of first connector 200 can laterally and rotationally move to the extent permitted by first fasteners 220 and opening 252. First fastener 220 can be screwed into, soldered to, or otherwise fixed to, connected to, or attached to a structure, such as a printed circuit board, or an internal housing or enclosure portion 110 as shown in FIG. 1. A second fastener can be inserted into threaded surface 222 of first fastener 220 to limit a vertical movement of housing 230 of first connector 200. This second fastener can include a widened top to cover opening 252. Alternatively, first fastener 220 can include a widened top to cover opening 252. An example is shown in the following figure.

FIG. 3 is a top view of a board-to-board connector according to an embodiment of the present invention. In this example, a second fastener 210 has been inserted into each first fastener 220 (shown in FIG. 2.) The top of each second fastener 210 in this example is shown as completely covering one or opening 252 or opening 232 (shown in FIG. 2.) Second fasteners 210 can include recessed persons 212 for accepting a tool used to turn second fasteners 210 during assembly. Second fasteners 210 can constrain vertical movement of housing 230 of first connector 200. As before, first connector 200 can include housing 230 partially shielded by shielding 250. Second connector 300 can include housing 330 supporting signal contacts 310 and power contacts 320. Second connector 300 can be fixed to main logic board 130 or other appropriate substrate as shown in FIG. 1. For example, signal contacts 310 and power contacts 320 can be soldered to corresponding pads on main logic board 130. Shield 350 can electrically connect to shield 250, and both can be grounded.

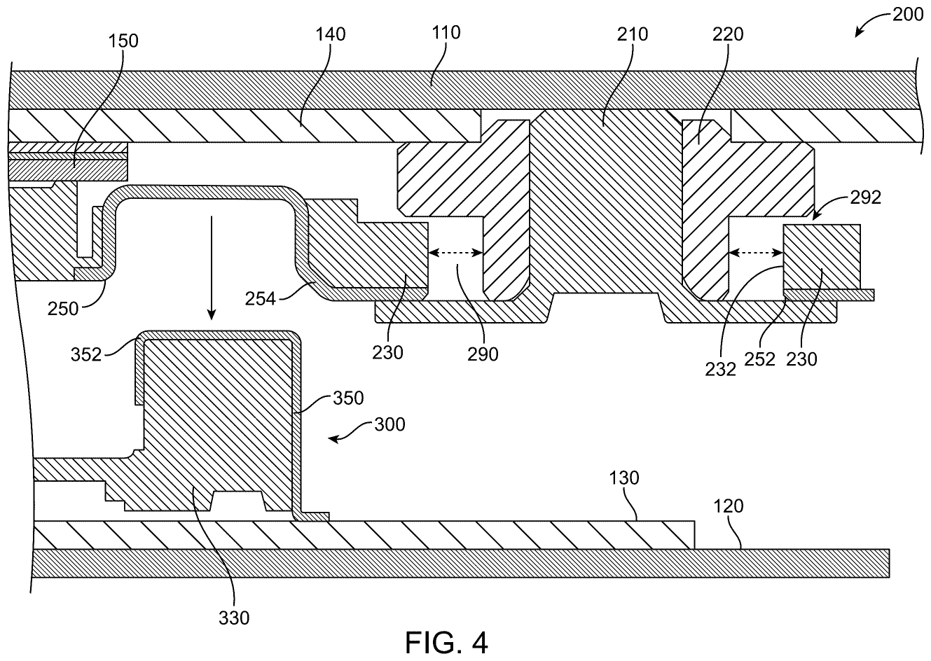

FIG. 4 is a cutaway side view of the board-to-board connector of FIG. 2 and FIG. 3. This figure is taken along a portion of cutline Y-Y as shown in FIG. 3 before first connector 200 and second connector 300 are mated. First connector 200 can be a receptacle. First connector 200 can include first fastener 220. First fastener 220 can be soldered or otherwise attached to either printed circuit board 140, internal housing or enclosure portion 110, or both. In these and other embodiments of the present invention, either printed circuit board 140 or internal housing or enclosure portion 110 can be omitted. First fastener 220 can be a shoulder pin or other type of fastener. First connector 200 can be fit to first fastener 220 such that first fastener 220 is located in opening 252 in shield 250 and opening 232 in housing 230. This arrangement can constrain the lateral and rotational movement of housing 230 relative to first fastener 220, printed circuit board 140, and internal housing or enclosure portion 110. That is, housing 230 can laterally and rotationally move through space 290. Second fastener 210 can be inserted into first fastener 220. A vertical gap 292 can be between housing 230 and first fastener 220. Housing 230 can move vertically an amount equal to the vertical gap 292.

Second fastener 210 can be a screw that is screwed into first fastener 220 or second fastener 210 can be another type of fastener. Shield 250 and contacts (not shown) supported by housing 230 of first connector 200 can be soldered to corresponding contacts on flexible circuit board 150. Flexible circuit board 150 can further be connected to either printed circuit board 140, or internal housing or enclosure portion 110. Flexible circuit board 150 can flex, fold, or bend to compensate for movement of housing 230 of first connector 200 when mated with second connector 300. Second connector 300 can include housing 330 partially shielded by shield 350. Shield 350, along with signal contacts 310 and power contacts 320 (all shown in FIG. 3), can be soldered to corresponding pads on main logic board 130. Main logic board 130 can be supported by second internal housing or enclosure portion 120.

In this example, first connector 200 is being mated with second connector 300. More specifically, first connector 200 is being lowered onto second connector 300. Shield 250 of first connector 200 can then form an electrical connection with shield 350 of second connector 300. Edges 254 of shield 250 and edges 352 of shield 350 can be chamfered to help guide shield 350 into shield 250 during assembly. Again, flexible circuit board 150 can take up slack that is necessary and caused by the movement of housing 230 of first connector 200.

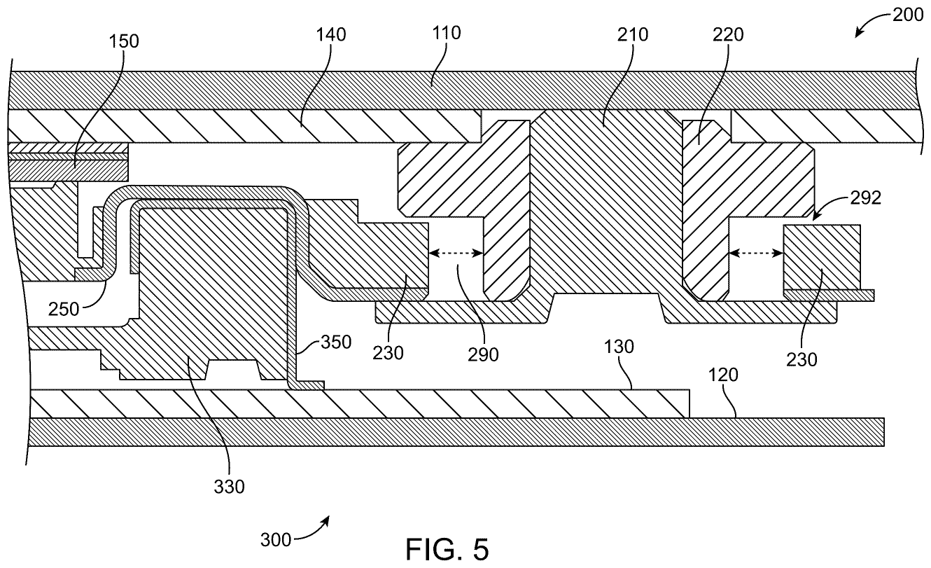

FIG. 5 is an assembled view of the board-to board connector shown in cutaway side view in FIG. 4. This figure is taken along a portion of cutline Y-Y as shown in FIG. 3. First connector 200 can be a receptacle and can include first fastener 220. First fastener 220 can be soldered or otherwise attached to either printed circuit board 140, internal housing or enclosure portion 110, or both. In these and other embodiments of the present invention, either printed circuit board 140 or internal housing or enclosure portion 110 can be omitted. First fastener 220 can be a shoulder pin or other type of fastener. First connector 200 has been fit to first fastener 220. This can constrain the lateral and rotational movement of housing 230 relative to first fastener 220, printed circuit board 140, and internal housing or enclosure portion 110. That is, housing 230 can laterally and rotationally move through space 290. Second fastener 210 has been inserted into first fastener 220. A vertical gap 292 can be between housing 230 and first fastener 220. Housing 230 can move vertically an amount equal to the vertical gap 292.

Second fastener 210 can be a screw that is screwed into first fastener 220 or second fastener 210 can be another type of fastener. Shield 250 and contacts (not shown) supported by housing 230 of first connector 200 can be soldered to corresponding contacts on flexible circuit board 150. Flexible circuit board 150 can further be connected to either printed circuit board 140, or internal housing or enclosure portion 110. Flexible circuit board 150 can flex, fold, or bend to compensate for movement of housing 230 of first connector 200 when mated with second connector 300. Second connector 300 can include housing 330 partially shielded by shield 350. Shield 350, along with signal contacts 310 and power contacts 320 (all shown in FIG. 3), can be soldered to corresponding pads on main logic board 130. Main logic board 130 can be supported by second internal housing or enclosure portion 120.

Traces or pads on either printed circuit board 140, or internal housing or enclosure portion 110 can be connected to traces or pads on flexible circuit board 150. Traces or pads on flexible circuit board 150 soldered to signal contacts and power contacts (not shown) of first connector 200. These signal contacts and power contacts can form physical and electrical connections with signal contacts 310 and power contacts 320 of second connector 300. Signal contacts 310 and power contacts 320 of second connector 300 can be soldered to traces or pads on main logic board 130. This can connect components that make up or are included on or as part of first internal housing or enclosure portion 110 or printed circuit board 140 and main logic board 130.

In this example, features of housing 230 and housing 330 can help to align first connector 200 to second connector 300. In these and other embodiments of the present invention, other alignment features can be used. In these examples, optional locking features can be employed as well. These locking features can also act or be used as alignment features. These locking features can help to prevent disconnections when an electronic device is dropped, exposed to prolonged vibrations, or experiences other forces. An example is shown in the following figure.

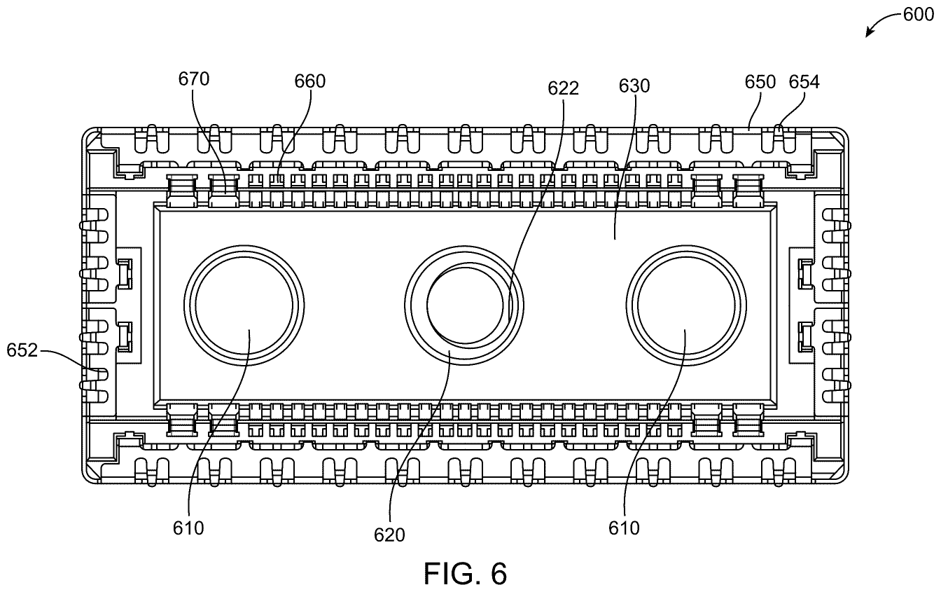

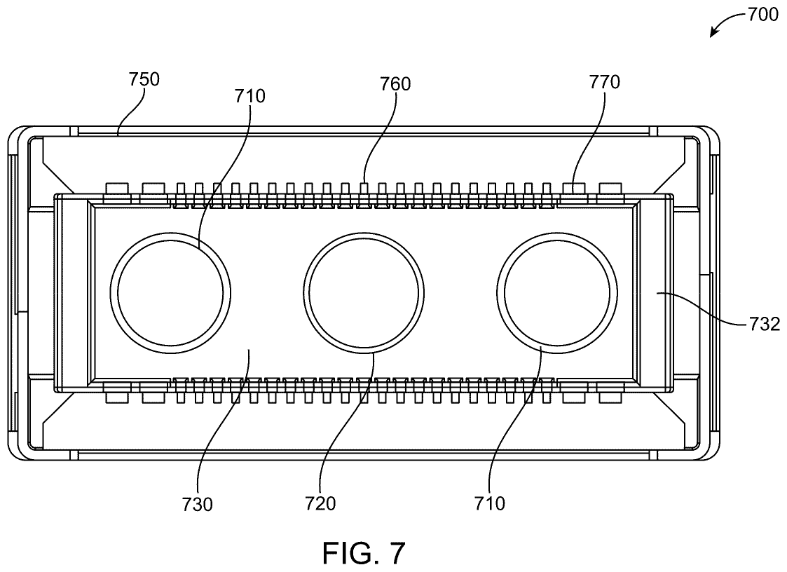

FIG. 6 illustrates a top view of a first connector of a board-to-board connector according to an embodiment of the present invention. First connector 600 can include housing 630 supporting alignment features 610. Alignment features 610 can be posts or protrusions extending from housing 630. Alignment features 610 can be formed as part of or separate from housing 630. Housing 630 can support signal contacts 660 and power contacts 670. As before, power contacts 670 can be larger to support the larger currents associated with power supplies. Housing 630 can be partially shielded by shields 650 and shields 652. Alignment features 610 can be aligned with openings 710 in housing 730 of second connector 700 (shown in FIG. 7.) First connector 600 can further include insert 620 or other locking feature. Insert 620 can include threaded inside surface 622. Insert 620 can extend from housing 630 and can be used as an alignment feature. Insert 620 can be formed as part of or separate from housing 630. Insert 620 can be formed of metal or other material. Shield 650 and shield 652 can include dimples 654 that can connect to shield 750 (shown in FIG. 7) to form a limited faraday cage around the first connector 600 and second connector 700.

FIG. 7 illustrates a top view of a second connector of a board-to-board connector according to an embodiment of the present invention. Second connector 700 can include housing 730 having openings 710 for alignment features 610 of first connector 600 (shown in FIG. 6.) Housing 730 can further include opening 720 to accept insert 620 of first connector 600. Housing 730 can support signal contacts 760 and power contacts 770. Some of housing 730 can be shielded by shield 750.

The alignment features such as the posts used for alignment features 610 (shown in FIG. 6) and openings 710, can be arranged to align first connector 600 to second connector 700 before signal contacts 660 and power contacts 670 (both shown in FIG. 6) of first connector 600 engage signal contacts 760 and power contacts 770 of second connector 700. This can ensure that contacts are not damaged during mating. In an illustrative embodiment, alignment features 610 and openings 710 can engage first, followed by insert 620 and opening 720, and then signal contacts 660 and power contacts 670 and signal contacts 760 and power contacts 770. Alignment features 610 can be tapered to allow an initial mismatch in the positioning of first connector 600 and second connector 700 during mating. An increase in the tapering of alignment features 610, the longer alignment features 610 might need to be to ensure that first connector 600 and second connector 700 are aligned before signal contacts 660 and power contacts 670 of first connector 600 engage signal contacts 760 and power contacts 770 of second connector 700.

Other contacts, such as signal contacts 760 and power contacts 770, can be located elsewhere on second connector 700 and they can mate with corresponding contacts positioned on first connector 600. For example, additional contacts can be located in regions 732 of housing 730. One or more contacts can be located around openings 710 and 720 and can mate with contacts located on corresponding alignment features 610 and insert 620 on first connector 600 (shown in FIG. 6.) Other features, such as ground contacts, can be placed at various locations, for example between rows of signal contacts 660 and power contacts 670 on first connector 600 and rows of signal contacts 760 and power contacts 770 on second connector 700. These ground contacts can provide an amount of isolation between these rows of contacts. This can further enhance the isolation provided by the increased spacing between rows of contacts due to the placement of alignments features 610 and insert 620.

These alignment features, such as the posts used for alignment features 610 and openings 710, can have various shapes. For example, they can have a circular cross-section as shown. The can instead have a “D” shape, “+” shape, or other shaped cross-section. Such a non-circular shape can be used as a keying feature to prevent a mis-mating of first connector 600 and second connector 700.

In this example, two posts are used as alignment features 610 and one insert 620 is used as a fastener. Each of these are located on housing 630 (shown in FIG. 6) of first connector 600. In these and other embodiments of the present invention, one or more of these features can be located on housing 730 of second connector 700. For example, alignment features 610 can be located on housing 630 while insert 620 can be located on housing 730. Alternatively, two inserts 620 can be located on either housing 630 or housing 730 and inserts 620 can be used as alignment features as well. Other combinations, such as one insert 620 and one alignment feature 610, or two inserts 620 and one alignment feature, can be used, and inserts 620 and alignment features 610 can be located on either or both housing 630 and housing 730.

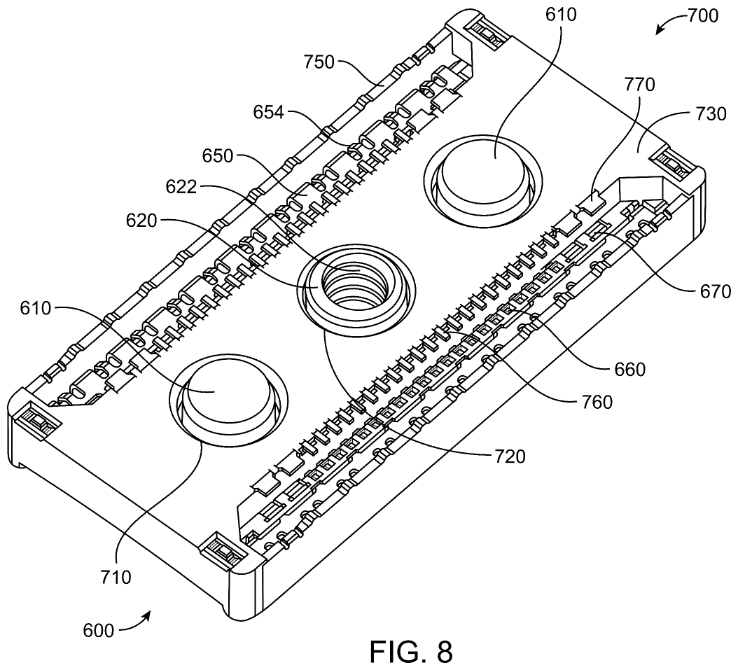

FIG. 8 illustrates an oblique bottom view of the first connector shown in FIG. 6 mated with the second connector shown in FIG. 7. In this example, alignment features 610 of first connector 600 can be positioned in a corresponding opening 710 of second connector 700. Insert 620 of first connector 600 can be located in opening 720 in housing 730 of second connector 700. Power contacts 770 can form connections for power supplies with power contacts 670. Signal contacts 660 can form electrical pathways for signals with signal contacts 760. Shield 650 of first connector 600 can electrically connect to shield 750 of second connector 700. Shield 650 can include dimples 654 that can connect to shield 750 to form a limited faraday cage around the first connector 600 and second connector 700.

Alignment features 610 can be flush or sub-flush with the bottom surface of housing 730 of second connector 700. Alternatively, alignment features 610 can extend past the bottom surface of housing 730 of second connector 700. This can allow alignment features 610 to extend into corresponding recesses (not shown) in a printed circuit board (not shown) or other substrate supporting second connector 700. Similarly, insert 620 can be flush or sub-flush with a bottom surface of housing 730 of second connector 700. Alternatively, insert 620 can extend beyond a bottom surface of housing 730 of second connector 700. Again, this can allow insert 620 to reside in a corresponding recess in a printed circuit board or other appropriate substrate that is supporting second connector 700. In some circumstances, routing in the printed circuit board supporting second connector can be too congested to allow the use of these corresponding recesses. Where these corresponding recesses are employed, they can form visual features that can be used when assembling an electronic device.

A fastener (not shown) can be threaded through threaded surface 622 of insert 620. For example, a fastener can be inserted through a printed circuit (not shown) supporting second connector 700. The fastener can pass through opening 710 in second connector 700 and into threaded surface 622 of insert 620. The fastener can have a widened head to help secure the printed circuit board, second connector 700, and first connector 600 together. Alternatively, the fastener can pass through the back side of the second connector 700 through opening 720 and into the threaded surface 622 of insert 620 of first connector 600. Again, the fastener can have a widened head to help secure second connector 700 and first connector 600 together. Alternatively, the fastener can be threaded beginning at the bottom of housing 630 of first connector 600 such that the fastener emerges from insert 620 at the bottom of housing 730 of the second connector 700. The fastener can be further screwed into a board or other appropriate substrate that supports second connector 700. Alternatively, a fastener can continue and pass through this board or other appropriate substrate and be held in place with a nut or other fastener on the other side of the printed circuit board. In these and other embodiments of the present invention, a fastener may be used with insert 620 to secure first connector 600 to second connector 700 in various ways.

Different types of fasteners can be used in these and other embodiments of the present invention. For example, one or more alignment features 610 can include a snaping or locking feature that can provide both a tactile response that a connection between first connector 600 and second connector 700 has been made as well as a locking feature that can help to prevent disconnections. For example, an alignment feature can include a circumferential groove that can support a coil spring, such as a canted coil spring, a C-clip, or other structure. During assembly, the spring, C-clip, or other structure can lock the alignment feature 610 to opening 710 in second connector 700. Opening 710 can have a contoured surface to provide a proper tactile response and retention force.

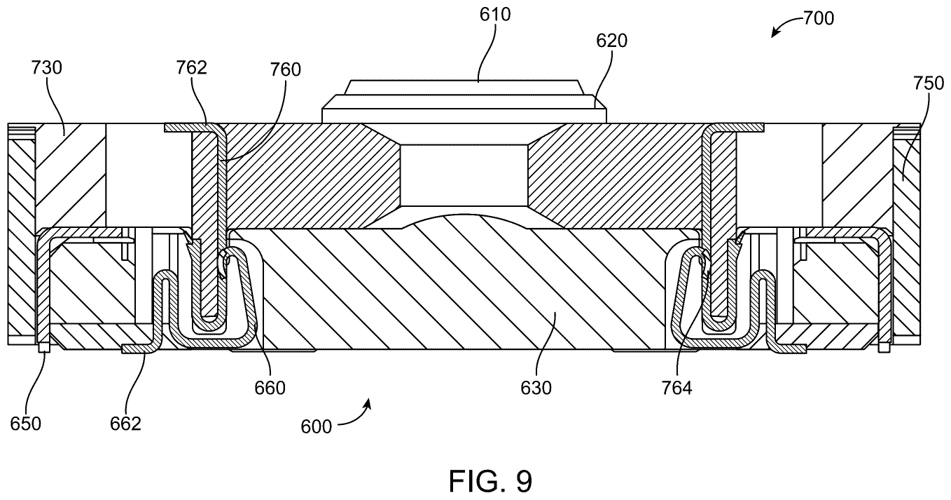

FIG. 9 illustrates a cutaway side view of the mated board-to-board connector of FIG. 8. In this example, second connector 700 has been mated with first connector 600. Alignment feature 610 and insert 620 of first connector 600 can extend beyond a bottom surface of housing 730 of second connector 700. Housing 630 can support signal contacts 660 and housing 730 of second connector 700 can support signal contacts 760. Signal contacts 760 can include surface-mount contacting portions 762 and signal contact 660 can include surface-mount contacting portions 662. Signal contact 660 can electrically connect to signal contact 760 at point 764. Shield 650 can connect to shield 750 of second connector 700.

These and other embodiments of the present invention can include other types of alignment features. Examples are shown in the following figures.

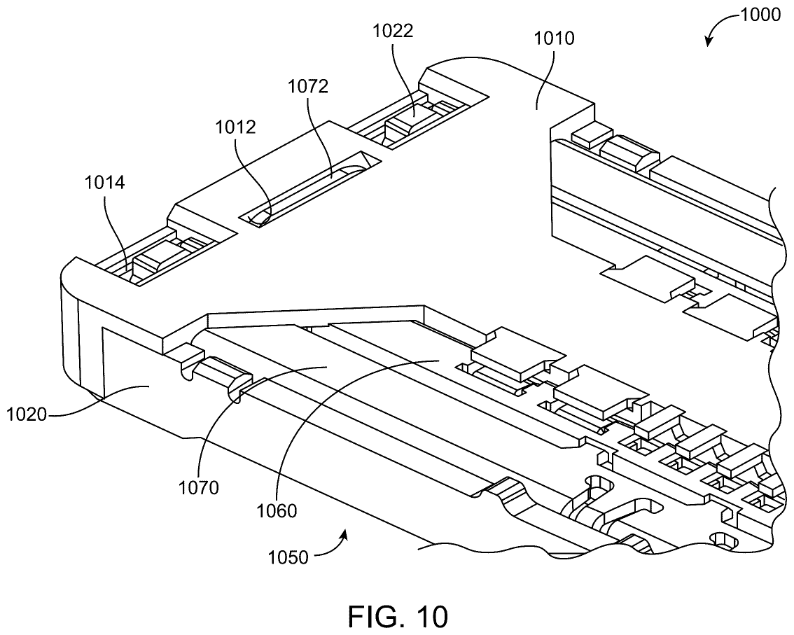

FIG. 10 illustrates a portion of a board-to-board connector according to an embodiment of the present invention. This example can include first connector 1000 having housing 1010. Housing 1010 can include slot 1012. Second connector 1050 can include housing 1060 and shield 1070. Shield 1070 can include tab 1072. During mating of first connector 100 second connector 1050, tab 1072 of second connector 1050 can fit through slot 1012 of first connector 1000 to align first connector 1000 to second connector 1050. First connector 1000 can further include shield 1020. Shield 1020 can include tabs 1022 that can fit in openings 1014 in housing 1010 during assembly of first connector 1000.

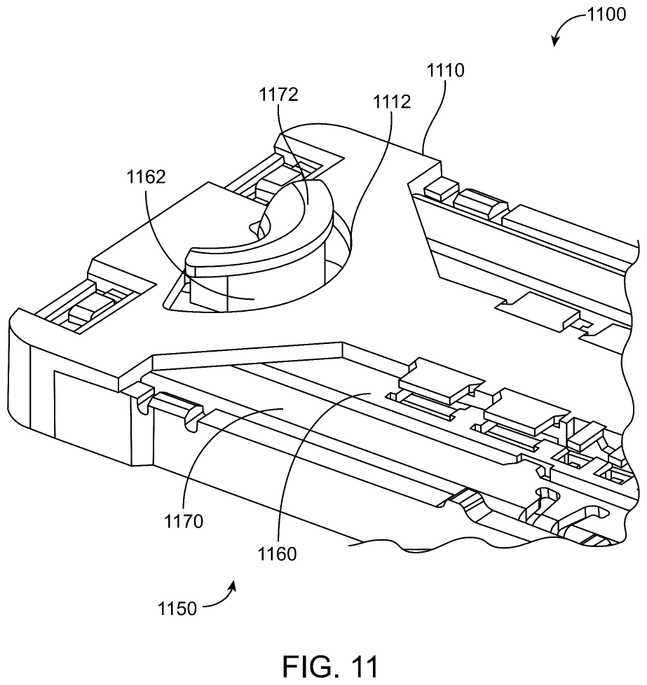

FIG. 11 illustrates a portion of a board-to-board connector according to an embodiment of the present invention. In this example, first connector 1100 can include housing 1110 having opening 1112. Second connector 1150 can include housing 1160 and shield 1170. Protrusion 1162 can extend from housing 1160 and can fit in opening 1112 of housing 1110. Shield 1170 can include protrusion 1172 that can fit with protrusion 1162.

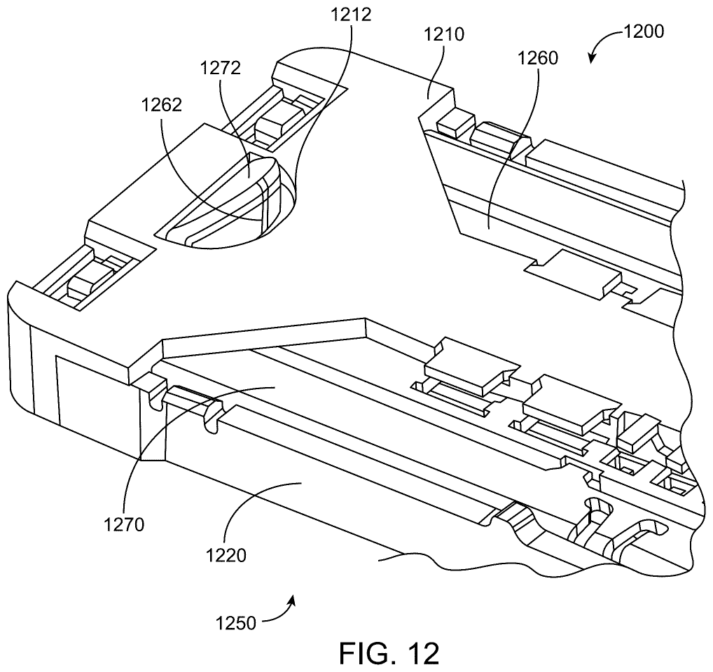

FIG. 12 illustrates a portion of a board-to-board connector according to an embodiment of the present invention. First connector 1200 can include housing 1210, which can include opening 1212. Second connector 1250 can include housing 1260 and shield 1270. Protrusion 1262 can extend from housing 1260 and protrusion 1272 can extend from shield 1270. Protrusion 1262 and 1272 can fit in opening 1212 to help align first connector 1200 to second connector 1250 during assembly. First connector 1200 can include shield 1220.

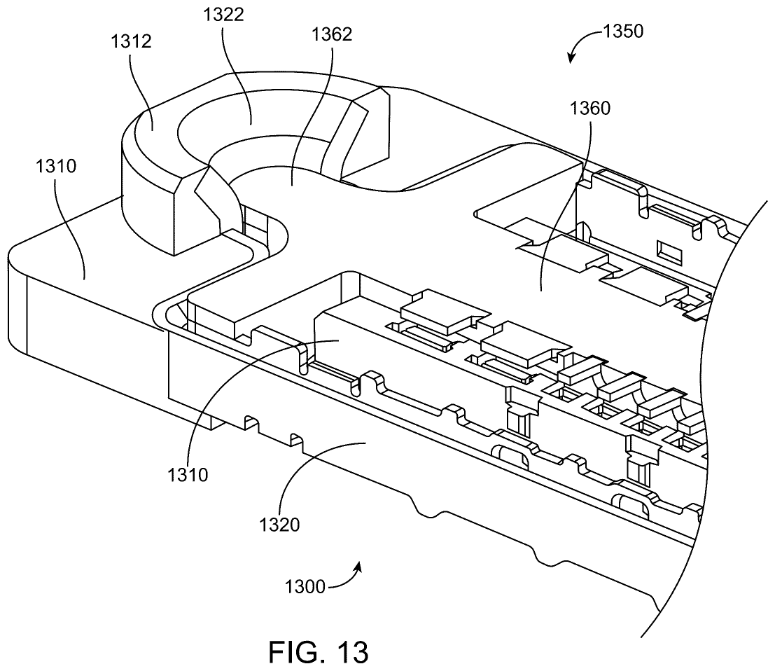

FIG. 13 illustrates a portion of a board-to-board connector according to an embodiment of the present invention. In this example, first connector 1300 can include housing 1310 and shield 1320. Protrusion 1312 can extend from housing 1310, and protrusion 1322 can extend from shield 1320. Second connector 1350 can include housing 1360. Housing 1360 can include extension 1362. When first connector 1300 is mated with second connector 1350, the sloped arc shape of protrusions 1312 and 1322 can guide extension 1362 of housing 1360 such that first connector 1300 is aligned to second connector 1350 during assembly.

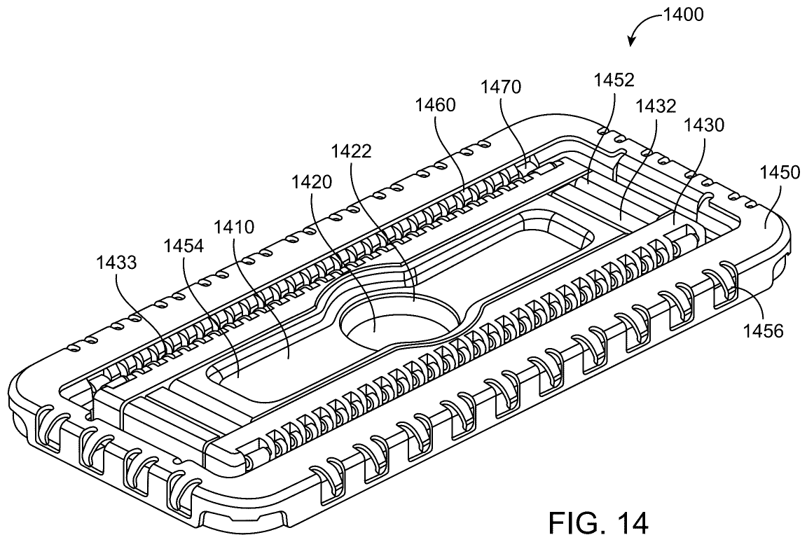

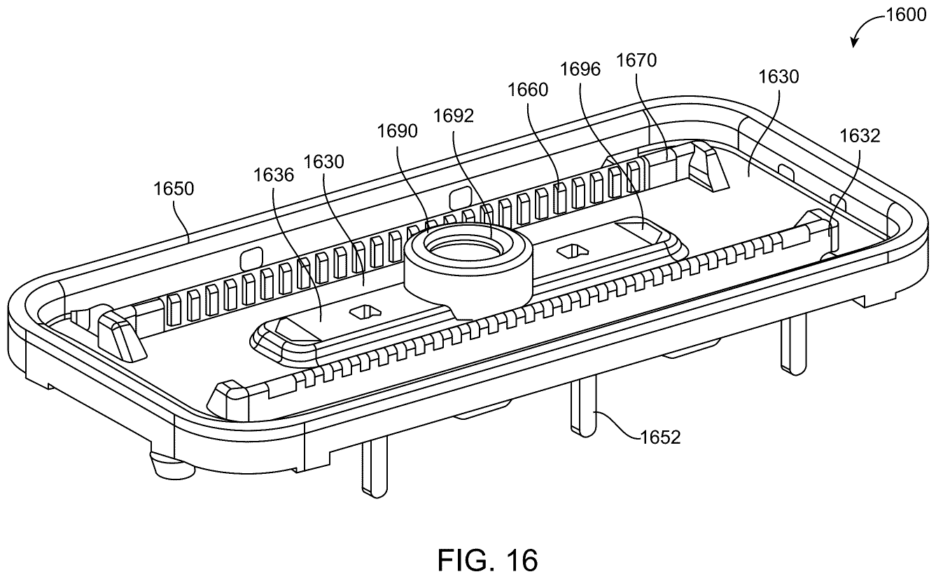

FIG. 14 illustrates a top view of a first connector for a board-to-board connector according to an embodiment of the present invention. First connector 1400 can include housing 1430 including reinforced trough or armored recess 1410. Armored recess 1410 can be a recessed portion in housing 1430 and can be protected by shield portion 1454. Armored recess 1410 can include opening 1420. Opening 1420 can have an inside surface 1422 that can be threaded or non-threaded. Shield portion 1454 can extend into opening 1420 to form inside surface 1422 to protect housing 1430. Housing 1430 can further support signal contacts 1460 and power contacts 1470, which can have contacting surface located in notches 1433. As in the examples above, power contacts 1470 can be larger to support the larger currents associated with power supplies. Housing 1430 can be partially shielded by shield 1450. Shield 1450 can be connected to shield portion 1454 through shield portion 1452. Shield 1450 can include tabs 1456 that can connect to shield 1650 (shown in FIG. 16) in second connector 1600 (shown in FIG. 16) to form a limited faraday cage around signal contacts 1460 and power contacts 1470 of first connector 1400 and signal contacts 1660 and power contacts 1670 of second connector 1600 (all shown in FIG. 16.)

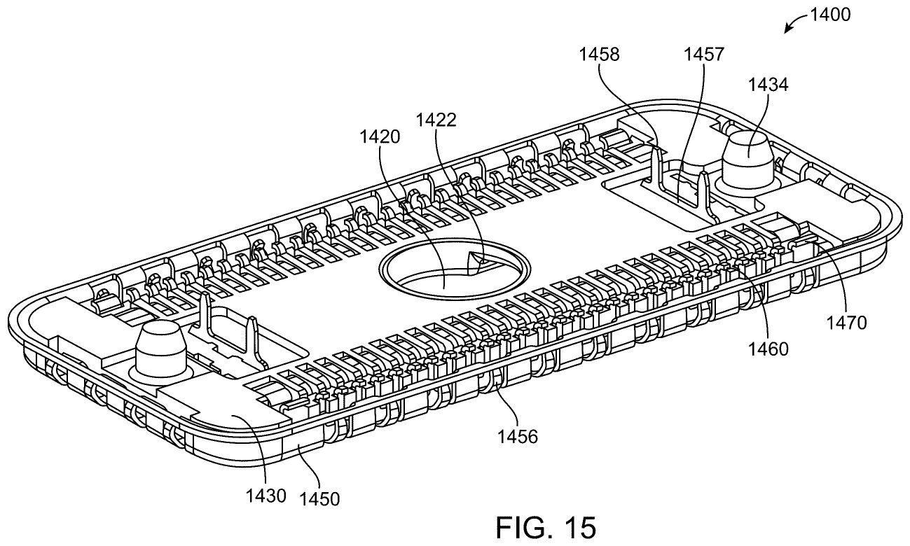

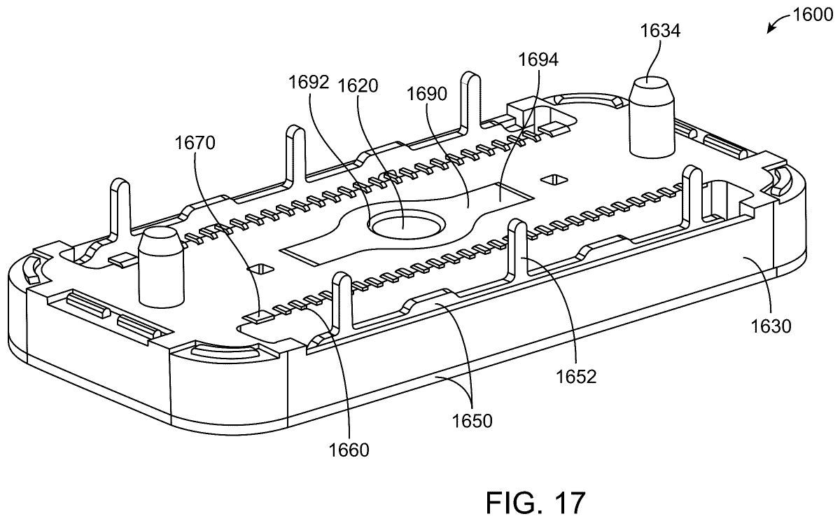

During assembly, a bottom of second connector 1600 (shown in FIG. 17) can be attached to a second board, such as a printed circuit board, flexible circuit board, or other appropriate substrate. A bottom of first connector 1400 (shown in FIG. 15) can be attached to a first board (not shown), such as a printed circuit board, flexible circuit board, or other appropriate substrate. First connector 1400 and second connector 1600 can be mated thereby connecting signal contacts 1460 to corresponding signal contacts 1660 in second connector 1600 and power contacts 1470 to corresponding power contacts 1670 in second connector 1600. The first board can have an opening aligned with opening 1420 in first connector 1400. A fastener (not shown), such as a screw, can pass through the opening in the first board and opening 1420 in first connector 1400. The fastener can include a head or wider portion to prevent the fastener from sliding through the opening in the first board. The fastener can be screwed into alignment feature 1690 (shown in FIG. 16) on second connector 1600, which can be a nut or similar structure. This can lock first connector 1400 to second connector 1600 and can help to prevent or reduce the likelihood of a disconnection during a force event, such as when an electronic device housing first connector 1400 and second connector 1600 is dropped.

In these and other embodiments of the present invention, alignment feature 1690 can be an alignment feature that provides alignment but does not provide a locking feature. Also, other locking arrangements can be used. For example, alignment feature 1690 can be shaped to snap into features on inside surface 1422 of opening 1420 on first connector 1400. Alignment feature 1690 can be a bolt having a head molded in or attached to housing 1630. The bolt can extend through opening 1420 in first connector 1400 and through the first board. A nut can be attached to the far side of the bolt (on the other side of the board as first connector 1400) to secure first connector 1400 to second connector 1600.

During assembly, boards can be attached to the bottoms of both first connector 1400 and second connector 1600. Accordingly, visibility of each connector can be poor. This can make alignment between first connector 1400 and second connector 1600 difficult. As a result, alignment feature 1690 can strike or otherwise make contact with recess 1410 in first connector 1400. This can damage housing 1430 or other portion of first connector 1400.

Accordingly, shield portion 1454 can protect housing 1430 from alignment feature 1690 during assembly. Without the armor provided by shield portion 1454, alignment feature 1690 could damage housing 1430. Even if such damage does not occur, forces applied through alignment feature 1690 of second connector 1600 can cause housing 1430 to distort, possibly damaging signal contacts 1460 and power contacts 1470, or causing their solder connections to a board or other substrate to be cracked or broken. The armor provided by shield portion 1454 can help to protect housing 1430 from damage or distortion cause by misalignment of second connector 1600 during assembly.

The features such as the armor provided by shield portion 1454 can help to prevent damage during assembly. These and other features can be included to help to reduce any misalignment between first connector 1400 and second connector 1600. For example, recess 1410 can be arranged to accept raised portion 1636 of housing 1630 (both shown in FIG. 16) of second connector 1600. Interfacing portions of housing 1430 can be tapered to avoid damage during mating. As shown above, alignment features, such as alignment feature 1690 on second connector 1600 and opening 1420, can be arranged to align first connector 1400 to second connector 1600 before signal contacts 1460 and power contacts 1470 of first connector 1400 engage signal contacts 1660 and power contacts 1670 of second connector 1600. This can ensure these contacts are not damaged during mating. That is, second connector 1600 can be aligned to first connector 1400, then rotated as needed into position for mating. In this example, alignment feature 1690 on second connector 1600 and opening 1420 can engage first, followed by signal contacts 1460 and power contacts 1470 engaging signal contacts 1660 and power contacts 1670 on second connector 1600. The area in recess 1410 around opening 1420 on first connector 1400 can be tapered to allow an initial mismatch in the positioning of first connector 1400 and second connector 1600 during mating. An increase in the tapering of the area around opening 1420 can necessitate the lengthening of alignment features 1690 on second connector 1600 to ensure that first connector 1400 and second connector 1600 are aligned before signal contacts 1460 and power contacts 1470 of first connector 1400 engage signal contacts 1660 and power contacts 1670 of second connector 1600.

It can be desirable to be able to disconnect first connector 1400 from second connector 1600. This can allow portions of an electronic device to be reworked. It can allow a user or third party to repair the electronic device. Accordingly, it can be desirable that such a disconnection be a clean release that does not damage either connector. This can be facilitated by the use of armor in the form of shield portion 1454. Also, a top of alignment feature 1690 can be tapered, as can other mating features. These features can allow an off-angle disconnect that provides a clean release that does not damage either connector.

Other contacts, such as signal contacts 1460 and power contacts 1470, can be located elsewhere on first connector 1400 and they can mate with corresponding contacts positioned on second connector 1600. For example, additional contacts can be located in regions 1432 of housing 1430. One or more contacts can be located around opening 1420 or elsewhere in armored recess 1410 and can mate with contacts located around a corresponding alignment feature on the second connector. Other features, such as ground contacts, can be placed at various locations, for example between rows of signal contacts 1460 and power contacts 1470 on first connector 1400. These ground contacts can provide an amount of isolation between these rows of contacts. This can further enhance the isolation provided by the increased spacing between rows of contacts due to the placement of opening 1420.

These alignment features, such as alignment feature 1690 on second connector 1600, as well as opening 1420, can have various shapes. For example, they can have a circular cross-section as shown. The can instead have a “D” shape, “+” shape, or other shaped cross-section. Such a non-circular shape can be used as a keying feature to prevent a mis-mating of first connector 1400 and second connector 1600.

In this example, alignment feature 1690 can be a post, bolt, nut, boss, insert, fastener, or other feature that can be used as alignment feature 1690 and inserted into opening 1420. In these and other embodiments of the present invention, one or more of these features can be located on housing 1630 of second connector 1600. For example, alignment feature 1690 can be attached to or formed as part of housing 1630 and can fit in opening 1420. Alternatively, two openings can be included in housing 1430 and two or more alignment features 1690 can be used as alignment features and inserted into two openings 1420. Other combinations, such as one opening 1420 and one alignment feature (not shown), or two openings 1420 and one alignment feature, can be used, and corresponding alignment features and openings can be located on housing 1430 or housing 1630 on second connector 1600.

In these embodiments of the present invention, first connector 1400 can have signal contacts 1460 and power contacts 1470 soldered to pads, openings, or traces on a first board (not shown), while signal contacts 1660 and power contacts 1670 on second connector 1600 can be soldered to pads, openings, or traces on a second board (not shown.) The first board and the second board can each be a printed circuit board, flexible circuit board, or other appropriate substrate. The pads, openings, or traces on the first board and the second board can connect to components on the first board, the second board, or both.

FIG. 15 illustrates a bottom view of the first connector of FIG. 14. As above, first connector 1400 can include housing 1430, which can include posts 1434. Posts 1434 can be inserted in a printed circuit board or other appropriate substrate for mechanical stability. First connector 1400 can include opening 1420. Opening 1420 can have an inside surface 1422 that can be threaded or non-threaded. Housing 1430 can support signal contacts 1460 and power contacts 1470. As in examples above, power contacts 1470 can be larger to support the larger currents associated with power supplies. Housing 1430 can be partially shielded by shield 1450. Shield 1450 can be connected to shield portion 1454 through shield portion 1452 (both shown in FIG. 14), though shield 1450 and shield portion 1454 can be separate. Shield 1450 can include tabs 1456 that can connect to shield 1650 in corresponding second connector 1600 (shown in FIG. 16) to form a limited faraday cage around signal contacts 1460 and power contacts 1470 in first connector 1400 and signal contacts 1660 and power contacts 1670 (both shown in FIG. 16) in second connector 1600. Shield portion 1457 can be formed as part of shield portion 1452 (shown in FIG. 14.) Through-hole contacts 1458 can extend from shield portion 1457 and can be inserted into holes or openings in a printed circuit board (not shown) or other appropriate substrate. This can provide mechanical support for first connector 1400 and can help to prevent damage during assembly, during a disconnect, or when an electronic device housing first connector 1400 experiences a force event, such as a drop.

As shown above, alignment features, such as alignment feature 1690 on second connector 1600 and opening 1420, can be arranged to align first connector 1400 to a second connector before signal contacts 1460 and power contacts 1470 of first connector 1400 engage signal contacts and power contacts (not shown) of the second connector. This can ensure that contacts are not damaged during mating. That is, second connector 1600 can be aligned to first connector 1400, then rotated as needed into position for mating. In this example, alignment feature 1690 on second connector 1600 and opening 1420 can engage first, followed by signal contacts 1460 and power contacts 1470 engaging signal contacts 1660 and power contacts 1670 on second connector 1600.

FIG. 16 illustrates a top view of a second connector for a board-to-board connector according to an embodiment of the present invention. Second connector 1600 can include housing 1630 supporting raised portion 1636 and raised portions 1632. Raised portions 1632 can support signals contacts 1660 and power contacts 1670. Raised portion 1636 can be reinforced with tabs 1696. Shield 1650 can be positioned around housing 1630. Through-hole contacts 1652 can extend from shield 1650 and can be inserted into openings or holes or openings in a printed circuit board (not shown) or other appropriate substrate. This can provide mechanical support for second connector 1600 and can help to prevent damage during assembly, during a disconnect, or when an electronic device housing second connector 1600 experiences a force event, such as a drop.

Alignment feature 1690 can be included. Alignment feature 1690 can be a nut, boss, post, or other feature. An inside surface 1692 of alignment feature 1690 can be threaded or non-threaded. Housing 1630 can be formed around alignment feature 1690, or alignment feature 1690 can be attached to housing 1630.

During assembly, a bottom of second connector 1600 can be attached to a second board, such as a printed circuit board, flexible circuit board, or other appropriate substrate. A bottom of first connector 1400 (shown in FIG. 15) can be attached to a first board (not shown), such as a printed circuit board, flexible circuit board, or other appropriate substrate. First connector 1400 and second connector 1600 can be mated. Raised portions 1632 can be inserted into notches 1433 (shown in FIG. 14) thereby connecting signal contacts 1460 to corresponding signal contacts 1660 in second connector 1600 and power contacts 1470 to corresponding power contacts 1670 in second connector 1600.) The first board can have an opening aligned with opening 1420 in first connector 1400. A fastener (not shown), such as a screw, can pass through the opening in the first board and opening 1420 (shown in FIG. 14) in first connector 1400. The fastener can include a head or wider portion to prevent the fastener from sliding through the opening in the first board. The fastener can be screwed into threaded inside surface 1692 in opening 1620 in alignment feature 1690 on second connector 1600, which can be a nut or similar structure. This can lock first connector 1400 to second connector 1600 and can help to prevent or reduce the likelihood of a disconnection during a force event, such as when an electronic device housing first connector 1400 and second connector 1600 is dropped. Raised portion 1636 of housing 1630 can be fit in recess 1410 (shown in FIG. 14) of first connector 1400. Tabs 1456 of shield 1450 (shown in FIG. 14) of first connector 1400 can contact shield 1650.

FIG. 17 illustrates a bottom view of the second connector of FIG. 16. Second connector 1600 can include housing 1630 supporting signals contacts 1660 and power contacts 1670. Shield 1650 can be positioned around housing 1630. Through-hole contacts 1652 can extend from shield 1650 and can be inserted into openings or holes or openings in a printed circuit board (not shown) or other appropriate substrate. Housing 1630 can include posts 1634. Posts 1634 can be inserted into openings or holes or openings in the printed circuit board or other appropriate substrate. Through-hole contacts 1652 and posts 1634 can provide mechanical support for second connector 1600 and can help to prevent damage during assembly, during a disconnect, or when an electronic device housing second connector 1600 experiences a force event, such as a drop.

Alignment feature 1690 can be included. Alignment feature 1690 can be a nut, boss, post, or other feature, and can include opening 1620. An inside surface 1692 of alignment feature 1690 can be threaded or non-threaded. Housing 1630 can be formed around alignment feature 1690, or alignment feature 1690 can be attached to housing 1630. Alignment feature 1690 can include wings 1694 to provide mechanical support for housing 1630. Wings 1694 can terminate in tabs 1696 (shown in FIG. 16.)

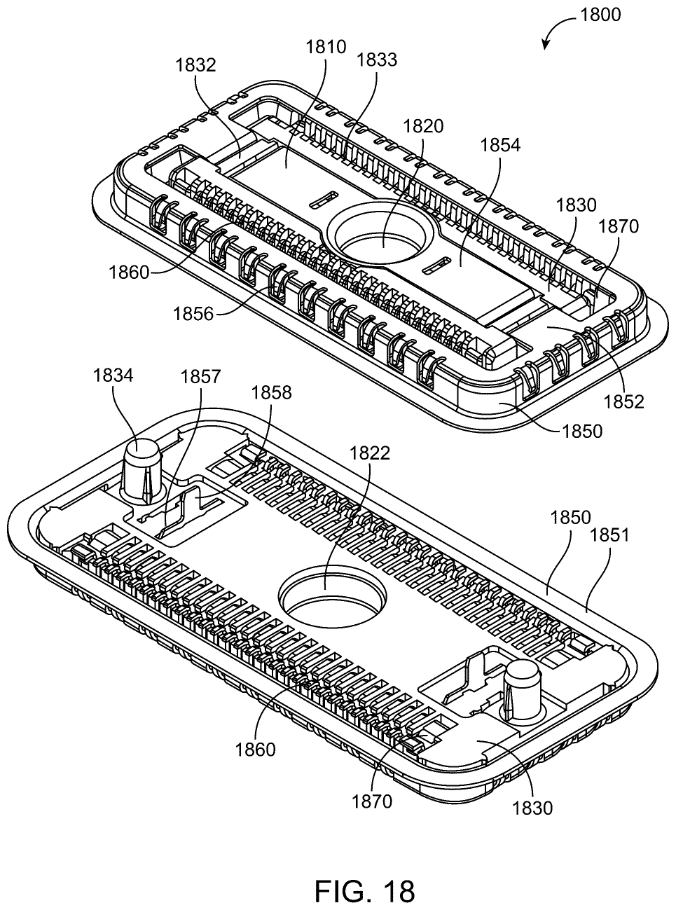

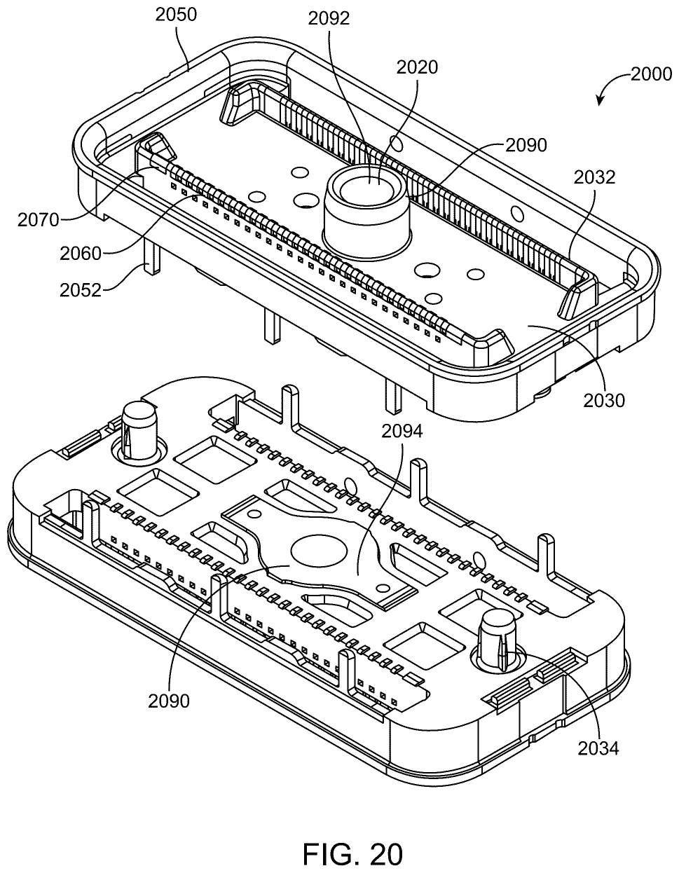

FIG. 18 illustrates top and bottom views of a first connector for a board-to-board connector according to an embodiment of the present invention. First connector 1800 can include housing 1830 including reinforced central portion 1810. Reinforced central portion 1810 can be protected by shield portion 1854. Reinforced central portion 1810 can include opening 1820. Opening 1820 can have an inside surface 1822 that can be threaded or non-threaded. Shield portion 1854 can extend into opening 1820 to form inside surface 1822 to protect housing 1830. Housing 1830 can further support signal contacts 1860 and power contacts 1870, which can have contacting surface located in notches 1833. As in the examples above, power contacts 1870 can be larger to support the larger currents associated with power supplies. Housing 1830 can be partially shielded by shield 1850. Shield 1850 can be connected to shield portion 1854 through shield portion 1852, or shield portion 1854 and shield 1850 can be separate. Shield 1850 can include tabs 1856 that can connect to shield 2050 (shown in FIG. 20) in second connector 2000 (shown in FIG. 20) to form a limited faraday cage around signal contacts 1860 and power contacts 1870 of first connector 1800 and signal contacts 2060 and power contacts 2070 of second connector 2000 (all shown in FIG. 20.)

During assembly, a bottom of second connector 2000 (shown in FIG. 20) can be attached to a second board, such as a printed circuit board, flexible circuit board, or other appropriate substrate. A bottom of first connector 1800 can be attached to a first board (not shown), such as a printed circuit board, flexible circuit board, or other appropriate substrate. First connector 1800 and second connector 2000 can be mated thereby connecting signal contacts 1860 to corresponding signal contacts 2060 in second connector 2000 and power contacts 1870 to corresponding power contacts 2070 in second connector 2000. The first board can have an opening aligned with opening 1820 in first connector 1800. A fastener (not shown), such as a screw, can pass through the opening in the first board and opening 1820 in first connector 1800. The fastener can include a head or wider portion to prevent the fastener from sliding through the opening in the first board. The fastener can be screwed into alignment feature 2090 (shown in FIG. 20) on second connector 2000, which can be a nut or similar structure. This can lock first connector 1800 to second connector 2000 and can help to prevent or reduce the likelihood of a disconnection during a force event, such as when an electronic device housing first connector 1800 and second connector 2000 is dropped.

In these and other embodiments of the present invention, alignment feature 2090 can be an alignment feature that provides alignment but does not provide a locking feature. Also, other locking arrangements can be used. For example, alignment feature 2090 can be shaped to snap into features on inside surface 1822 of opening 1820 on first connector 1800. Alignment feature 2090 can be a bolt having a head molded in or attached to housing 2030. The bolt can extend through opening 1820 in first connector 1800 and through the first board. A nut can be attached to the far side of the bolt (on the other side of the board as first connector 1800) to secure first connector 1800 to second connector 2000.

During assembly, boards can be attached to the bottoms of both first connector 1800 and second connector 2000. Accordingly, visibility of each connector can be poor. This can make alignment between first connector 1800 and second connector 2000 difficult. As a result, alignment feature 2090 can strike or otherwise make contact with reinforced central portion 1810 in first connector 1800. This can damage housing 1830 or other portion of first connector 1800.

Accordingly, shield portion 1854 can protect housing 1830 from alignment feature 2090 during assembly. Without the armor provided by shield portion 1854, alignment feature 2090 could damage housing 1830. Even if such damage does not occur, forces applied through alignment feature 2090 of second connector 2000 can cause housing 1830 to distort, possibly damaging signal contacts 1860 and power contacts 1870, or causing their solder connections to a board or other substrate to be cracked or broken. The armor provided by shield portion 1854 can help to protect housing 1830 from damage or distortion cause by misalignment of second connector 2000 during assembly.

The features such as the armor provided by shield portion 1854 can help to prevent damage during assembly. These and other features can be included to help to reduce any misalignment between first connector 1800 and second connector 2000. For example, interfacing portions of housing 1830 can be tapered to avoid damage during mating. As shown above, alignment features, such as alignment feature 2090 on second connector 2000 and opening 1820, can be arranged to align first connector 1800 to second connector 2000 before signal contacts 1860 and power contacts 1870 of first connector 1800 engage signal contacts 2060 and power contacts 2070 of second connector 2000. This can ensure these contacts are not damaged during mating. That is, second connector 2000 can be aligned to first connector 1800, then rotated as needed into position for mating. In this example, alignment feature 2090 on second connector 2000 and opening 1820 can engage first, followed by signal contacts 1860 and power contacts 1870 engaging signal contacts 2060 and power contacts 2070 on second connector 2000. The area in reinforced central portion 1810 around opening 1820 on first connector 1800 can be tapered to allow an initial mismatch in the positioning of first connector 1800 and second connector 2000 during mating. An increase in the tapering of the area around opening 1820 can necessitate the lengthening of alignment features 2090 on second connector 2000 to ensure that first connector 1800 and second connector 2000 are aligned before signal contacts 1860 and power contacts 1870 of first connector 1800 engage signal contacts 2060 and power contacts 2070 of second connector 2000.

It can be desirable to be able to disconnect first connector 1800 from second connector 2000. This can allow portions of an electronic device to be reworked. It can allow a user or third party to repair the electronic device. Accordingly, it can be desirable that such a disconnection be a clean release that does not damage either connector. This can be facilitated by the use of armor in the form of shield portion 1854. Also, a top of alignment feature 2090 can be tapered, as can other mating features. These features can allow an off-angle disconnect that provides a clean release that does not damage either connector.

Other contacts, such as signal contacts 1860 and power contacts 1870, can be located elsewhere on first connector 1800 and they can mate with corresponding contacts positioned on second connector 2000. For example, additional contacts can be located in regions 1832 of housing 1830. One or more contacts can be located around opening 1820 or elsewhere in armored reinforced central portion 1810 and can mate with contacts located around a corresponding alignment feature on the second connector. Other features, such as ground contacts, can be placed at various locations, for example between rows of signal contacts 1860 and power contacts 1870 on first connector 1800. These ground contacts can provide an amount of isolation between these rows of contacts. This can further enhance the isolation provided by the increased spacing between rows of contacts due to the placement of opening 1820.

These alignment features, such as alignment feature 2090 on second connector 2000, as well as opening 1820, can have various shapes. For example, they can have a circular cross-section as shown. The can instead have a “D” shape, “+” shape, or other shaped cross-section. Such a non-circular shape can be used as a keying feature to prevent a mis-mating of first connector 1800 and second connector 2000.

In this example, alignment feature 2090 can be a post, bolt, nut, boss, insert, fastener, or other feature that can be used as alignment feature 2090 and inserted into opening 1820. In these and other embodiments of the present invention, one or more of these features can be located on housing 2030 of second connector 2000. For example, alignment feature 2090 can be attached to or formed as part of housing 2030 and can fit in opening 1820. Alternatively, two openings can be included in housing 1830 and two or more alignment features 2090 can be used as alignment features and inserted into two openings 1820. Other combinations, such as one opening 1820 and one alignment feature (not shown), or two openings 1820 and one alignment feature, can be used, and corresponding alignment features and openings can be located on housing 1830 or housing 2030 on second connector 2000.

In these embodiments of the present invention, first connector 1800 can have signal contacts 1860 and power contacts 1870 soldered to pads, openings, or traces on a first board (not shown), while signal contacts 2060 and power contacts 2070 on second connector 2000 can be soldered to pads, openings, or traces on a second board (not shown.) The first board and the second board can each be a printed circuit board, flexible circuit board, or other appropriate substrate. The pads, openings, or traces on the first board and the second board can connect to components on the first board, the second board, or both. Rim 1851 of shield 1850 can be soldered to the first board. The soldering bond quality and positional consistency can be enhanced through selective or segmented plating. Accordingly, these and other embodiments of the present invention can include soldering segments (not shown) along rim 1851 on the bottom of shield 1850. These soldering segments can be plated with a soldering enhancing material such as gold flash or other material. These soldering segments can be square, rectangular, circular, or they can have other shapes. These soldering segments can mate with corresponding solder pads (not shown) on the first board. The portions of rim 1851 between these soldering segments can be left in place or they can be removed, for example by stamping. Housing 1830 can be modified to provide support to rim 1851.

Housing 1830 can include posts 1834. Posts 1834 can be inserted in a printed circuit board or other appropriate substrate for mechanical stability. Widened through-hole contacts 1858 can extend from tabs 1857 and can be inserted into holes or openings in a printed circuit board (not shown) or other appropriate substrate. Posts 1834 and widened through-hole contacts 1858 can provide mechanical support for first connector 1800 and can help to prevent damage during assembly, during a disconnect, or when an electronic device housing first connector 1800 experiences a force event, such as a drop.

As shown above, alignment features, such as alignment feature 2090 on second connector 2000 and opening 1820, can be arranged to align first connector 1800 to a second connector before signal contacts 1860 and power contacts 1870 of first connector 1800 engage signal contacts and power contacts (not shown) of the second connector. This can ensure that contacts are not damaged during mating. That is, second connector 2000 can be aligned to first connector 1800, then rotated as needed into position for mating. In this example, alignment feature 2090 on second connector 2000 and opening 1820 can engage first, followed by signal contacts 1860 and power contacts 1870 engaging signal contacts 2060 and power contacts 2070 on second connector 2000.

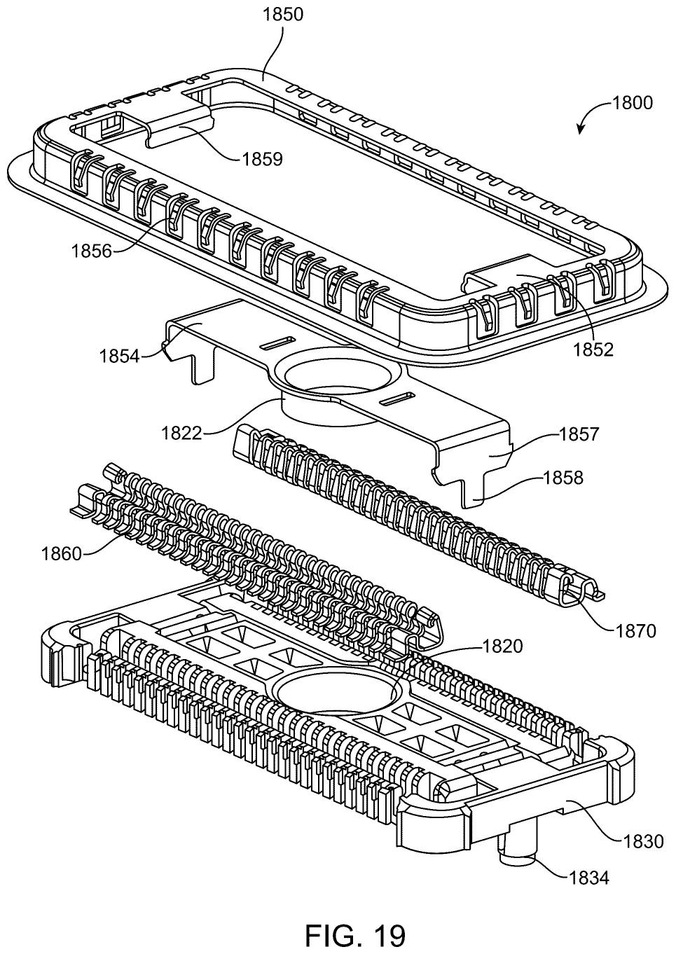

FIG. 19 illustrates an exploded view of the first connector shown in FIG. 18. First connector 1800 can include shield 1850. Shield 1850 can be formed of stainless steel or other material. Shield 1850 can be plated, for example using gold, silver, a gold flash and nickel underplate, palladium, or other materials. Shield 1850 can be formed by deep drawing, forging, coining, or other process. Shield 1850 can include tabs 1856 that can contact shield 2050 on second connector 2000. Shield portions 1852 can extend from shield 1850 and can terminate in tabs 1859.

Shield portion 1854 can be formed of stainless steel or other material. Shield portion 1854 can be plated, for example using gold, silver, a gold flash and nickel underplate, palladium, or other materials. Shield portion 1854 can be formed by deep drawing, forging, coining, or other process. Shield portion 1854 can include tabs 1857 that can terminate in widened through-hole contacts 1858. Tabs 1857 can be soldered or spot welded to tabs 1859 to connect shield 1850 and shield portion 1854, or shield 1850 and shield portion 1854 can be separate.

Signal contacts 1860 and power contacts 1870 can be formed of a copper-nickel-silicon based or other material and can be stamped or formed using another process. Some or all of signal contacts 1860 and power contacts 1870 can be plated with gold or other durable high-conductivity material.

Housing 1830 can be formed of a liquid crystal polymer, nylon, glass-filled nylon, or other nonconductive material. Housing 1830 can be formed using injection molding, 3-D printing, or other process. Housing 1830 can include opening 1820 and posts 1834. Opening 1820 can be protected by inside surface 1822, which can be formed as part of shield portion 1854.

FIG. 20 illustrates top and bottom views of a second connector for a board-to-board connector according to an embodiment of the present invention. Second connector 2000 can include housing 2030 supporting raised portions 2032. Raised portions 2032 can support signals contacts 2060 and power contacts 2070. Shield 2050 can be positioned around housing 2030. Through-hole contacts 2052 can extend from shield 2050 and can be inserted into openings or holes or openings in a printed circuit board (not shown) or other appropriate substrate. This can provide mechanical support for second connector 2000 and can help to prevent damage during assembly, during a disconnect, or when an electronic device housing second connector 2000 experiences a force event, such as a drop.

Alignment feature 2090 can be included. Alignment feature 2090 can be a nut, boss, post, or other feature. An inside surface 2092 of alignment feature 2090 can be threaded or non-threaded. Housing 2030 can be formed around alignment feature 2090, or alignment feature 2090 can be attached to housing 2030.

During assembly, a bottom of second connector 2000 can be attached to a second board, such as a printed circuit board, flexible circuit board, or other appropriate substrate. A bottom of first connector 1800 (shown in FIG. 15) can be attached to a first board (not shown), such as a printed circuit board, flexible circuit board, or other appropriate substrate. First connector 1800 and second connector 2000 can be mated. Raised portions 2032 can be inserted into notches 1833 (shown in FIG. 18) thereby connecting signal contacts 1860 to corresponding signal contacts 2060 in second connector 2000 and power contacts 1870 to corresponding power contacts 2070 in second connector 2000. The first board can have an opening aligned with opening 1820 in first connector 1800. A fastener (not shown), such as a screw, can pass through the opening in the first board and opening 1820 (shown in FIG. 18) in first connector 1800. The fastener can include a head or wider portion to prevent the fastener from sliding through the opening in the first board. The fastener can be screwed into threaded sides in opening 2020 in alignment feature 2090 on second connector 2000, which can be a nut or similar structure. This can lock first connector 1800 to second connector 2000 and can help to prevent or reduce the likelihood of a disconnection during a force event, such as when an electronic device housing first connector 1800 and second connector 2000 is dropped. Tabs 1856 of shield 1850 (shown in FIG. 18) of first connector 1800 can contact shield 2050.

Housing 2030 can include posts 2034. Posts 2034 can be inserted into openings or holes or openings in the printed circuit board or other appropriate substrate. Through-hole contacts 2052 and posts 2034 can provide mechanical support for second connector 2000 and can help to prevent damage during assembly, during a disconnect, or when an electronic device housing second connector 2000 experiences a force event, such as a drop.

Alignment feature 2090 can be a nut, boss, post, or other feature, and can include opening 2020. An inside surface 2092 of alignment feature 2090 can be threaded or non-threaded. Housing 2030 can be formed around alignment feature 2090, or alignment feature 2090 can be attached to housing 2030. Alignment feature 2090 can include wings 2094 to provide mechanical support for housing 2030. Wings 2094 can terminate in tabs 2096 (shown in FIG. 20.)

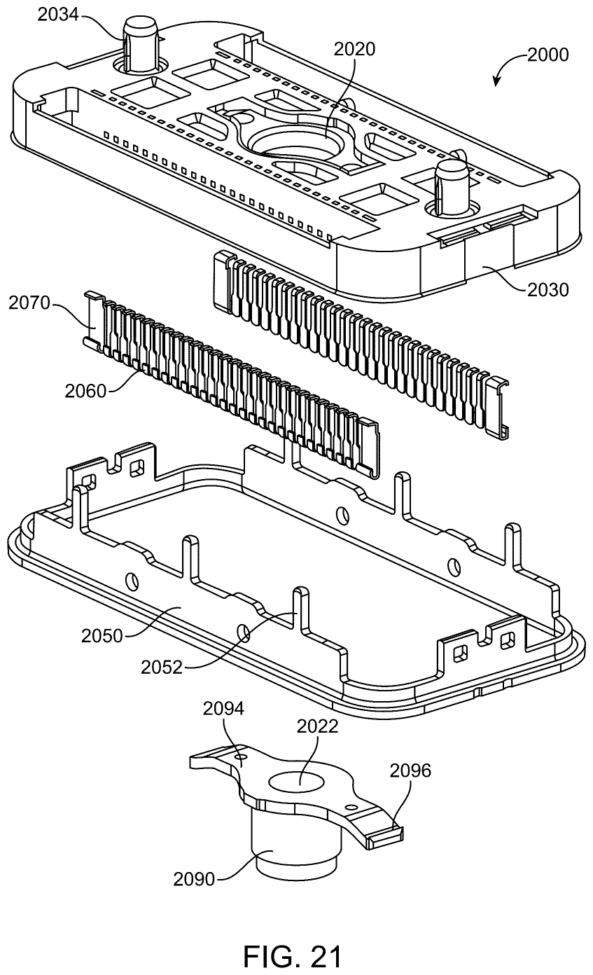

FIG. 21 illustrates an exploded view of the second connector shown in FIG. 20. Second connector 2000 can include shield 2050. Shield 2050 can be formed of stainless steel or other material. Shield 2050 can be plated, for example using gold, silver, a gold flash and nickel underplate, palladium, or other materials. Shield 2050 can be formed by deep drawing, forging, coining, or other process. Through-hole contacts 2052 can extend from shield 2050 and can be inserted into openings in a board (not shown) or other appropriate substrate.

Alignment feature 2090 can be formed of stainless steel or other material. Alignment feature 2090 can be plated, for example using gold, silver, a gold flash and nickel underplate, palladium, or other materials. Alignment feature 2090 can be formed by deep drawing, forging, coining, or other process. Alignment feature 2090 can include wings 2094 that can terminate in tabs 2096. Housing 2030 can be molded around tabs 2096 to secure alignment feature 2090 in place in second connector 2000. Alignment feature 2090 can include inside surface 2022 for accepting a screw or other fastener.

Signal contacts 2060 and power contacts 2070 can be formed of a copper-nickel-silicon based or other material and can be stamped or formed using another process. Some or all of signal contacts 2060 and power contacts 2070 can be plated with gold or other durable, high-conductivity material.

Housing 2030 can be formed of a liquid crystal polymer, nylon, glass-filled nylon, or other nonconductive material. Housing 2030 can be formed using injection molding, 3-D printing, or other process. Housing 2030 can include opening 2020 and posts 2034. Opening 2020 can be protected by inside surface 2022, which can be formed as part of alignment feature 2090.

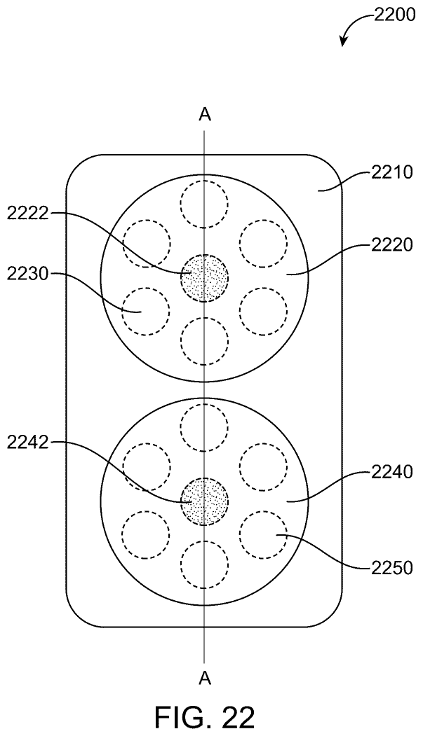

FIG. 22 illustrates a top view of a board-to-board connector according to an embodiment of the present invention. Conventional low-height connections often rely on and include a hot-bar solder connection. But these connections can be difficult to rework, leading to yield loss and additional consumption of resources. Accordingly, board-to-board connector 2200 can provide a minimally spaced connection that is robust and easy to assemble, repair, and rework.

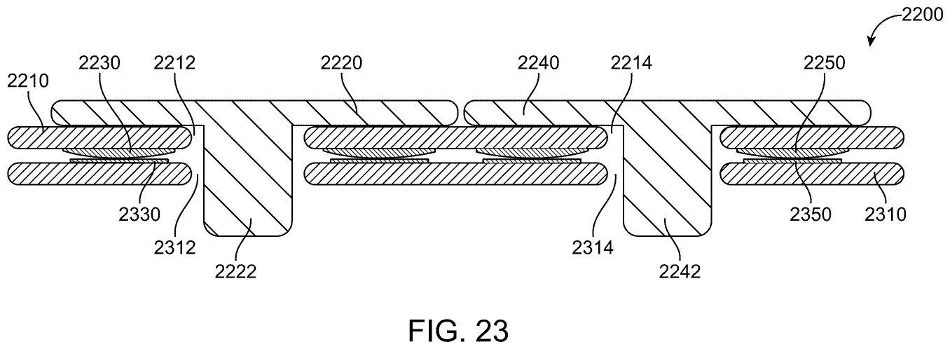

Board-to-board connector 2200 can include a top board 2210 and a bottom board 2310 (shown in FIG. 23) secured to each other by fastener 2220 and fastener 2240. Fastener 2220 and fastener 2240 can be used to mate two printed circuit boards, one printed circuit board and one flexible circuit board, or two flexible circuit boards. That is, both top board 2210 and bottom board 2310 can be either a printed circuit board or a flexible circuit board. Contacts 2230 on a bottom surface of top board 2210 can form electrical connections with contacts 2330 (shown in FIG. 23) on a top of bottom board 2310. Contacts 2250 on a bottom surface of top board 2210 can form electrical connections with contacts 2350 (shown in FIG. 23) on a top of bottom board 2310. Contacts 2230, contacts 2330, contacts 2250, and contacts 2250 can connect to traces and components on top board 2210 and bottom board 2310.

During assembly, top board 2210 and bottom board 2310 can be aligned. Fastener 2220 can be inserted through a first opening 2212 in top board 2210 and a first opening 2312 (both shown in FIG. 23) in bottom board 2310. The fastener 2220 can included a threaded portion (not shown) on shaft 2222. Fastener 2220 can be threaded into a nut, a threaded portion of a housing, or other threaded structure (not shown.) The nut can be at a bottom side of bottom board 2310, particularly when bottom board 2310 is a printed circuit board or a substantial flexible circuit board. Bottom board 2310 can be on top of a printed circuit board, housing portion, or other appropriate substrate (not shown.) Fastener 2220 can pass through an opening in that substrate and can be threaded into a nut that is on a bottom side or otherwise in or attached to the substrate. For example, a nut can be soldered into an opening in a printed circuit board. The nut can be molded into an opening in a housing. Instead of a nut, the opening in the housing can be threaded. Using an opening in the housing can align and position top board 2210 and bottom board 2310 to the housing. A threaded post (not shown) can replace a nut, where the threaded post extends from a substrate or from the second board. Fastener 2220 can include a threaded opening that accepts the post to secure top board 2210 and bottom board 2310 together. Fastener 2220 can instead be a rivet or other attachment. Rework can be performed on such a structure by drilling out the rivet. Fastener 2220 can be used to secure other structures as well inside an electronic device that houses board-to-board connector 2200.

Fastener 2220 (and fastener 2240) can be formed of one or more parts. For example, shaft 2222 can be a threaded post that threads into an opening in the head of fastener 2220. Shaft 2222 can be threaded and can fit through an opening the head of fastener 2220. In this arrangement, shaft 2222 can have a tapered head that can fit in a tapered opening the head of fastener 2220. Fastener 2220 can be another type of fastener, such as a clip, a press-fit shaft, or other fastener. Shaft 2222 can be conductive or nonconductive, while the head of fastener 2220 can be conductive or nonconductive.

Once fastener 2220 is attached, fastener 2240 can be fastened in the same or similar manner as fastener 2220. Alternatively, fastener 2240 can be fastened using one or more of the same or similar structures as described above regarding fastener 2220. Alternatively, fastener 2240 can use other structures. For example, while both fastener 2220 and fastener 2240 are shown as having a circular head, one of fastener 2220 and fastener 2240 can have a square head. This arrangement can prevent interference from the first attached fastener interfering with the second attached fastener, so long as the fastener with the square head is attached first.

Instead of a fastener 2240, an alignment feature could be used. For example, fastener 2220 can be relied on to secure top board 2210 to bottom board 2310. Instead of a second fastener 2240, a feature on either or both top board 2210 and bottom board 2310 can align to a feature, for example on a housing for rotational control. A pin fit through an opening (not shown) in top board 2210 to bottom board 2310 can be used to align top board 2210 to bottom board 2310, and to a housing or other substrate as needed. The pin can be left in place or removed later.

A waterproof or liquid resistant board-to-board connector can be provided by these and other embodiments of the present invention. For example, a gasket (not shown) can be placed around the group of contacts 2230, contacts 2330, contacts 2250, and contacts 2350 and between top board 2210 and bottom board 2310. The gasket can be at least partially placed below either or both fastener 2220 and fastener 2240. Fastener 2220 and fastener 2240 can hold the gasket in place thereby forming a seal.

Shielding can be added to board-to-board connector 2200. For example, conductive foam or other shielding can be placed around the group of contacts 2230, contacts 2330, contacts 2250, and contacts 2350 and between top board 2210 and bottom board 2310. The conductive foam can be at least partially placed below either or both fastener 2220 and fastener 2240. Fastener 2220 and fastener 2240 can hold the conductive foam in place. Conductive foam can also or instead be placed between heads of either or both fastener 2220 and fastener 2240 and a top surface of top board 2210. The top surface of top board 2210 can be plated to make electrical contact with heads of either or both fastener 2220 and fastener 2240 for shielding.

Locking features can be included to secure the components for board-to-board connector 2200 to each other. For example, an adhesive can be used to secure either or both fastener 2220 and fastener 2240 to their respective nuts or other threaded portions. A wire can be passed through fastener 2220 and fastener 2240 to secure them in place to each other. A portion of the top surface of top board 2210 can be roughen, coated with a tacky substance, or otherwise be provided with an increased stiction to prevent accidental loosing of either or both fastener 2220 and fastener 2240 during use.

These and other embodiments of the present can include other components. For example, one or more antennas can be added to board-to-board connector 2200. For example, a portion of the top of top board 2210 can be plated and connected to ground. Fastener 2220, or a portion of fastener 2220 such as shaft 2222, can be used as an antenna feed. To protect the plated region on top of top board 2210, a stiffener (not shown) can be located between the top of top board 2210 and an underside of fastener 2220. An adhesive can be used to hold the stiffener in place. A head of fastener 2220 can be formed of plastic to protect the plated region.

FIG. 23 illustrates a cutaway side view of the board-to-board connector of FIG. 22. Board-to-board connector 2200 can include top board 2210 and bottom board 2310. Top board 2210 and bottom board 2310 can be secured using fastener 2220 and fastener 2240. Contacts 2230 and contacts 2250 can be located on a bottom side of top board 2210. Contacts 2230 and contacts 2250 can be formed as solder bumps. Contacts 2330 and contacts 2350 can be formed as flat contacts. Contacts 2330 and contacts 2350 can be located on a top surface of bottom board 2310 and can form electrical connections with contacts 2230 and contacts 2250, respectively. Contacts 2230, contacts 2250, contacts 2330, and contacts 2350 can convey power, ground, signals, or other voltages and currents. Contacts 2230, contacts 2250, contacts 2330, and contacts 2350 are shown as having the same or similar size, though one or more can be larger or smaller. For example, contacts that are designated to convey power or ground can be made larger. Fastener 2220 and fastener 2240 can provide pressure such that contacts 2230 and contacts 2250 can form robust electrical connections with contacts 2330 and contacts 2350.

Some or all of contacts 2230, contacts 2250, contacts 2330, and contacts 2350, can be below heads of fastener 2220 and fastener 2240. This can obviate the need for a cowling on top of board-to-board connector 2200, which can simplify the connection. Also, multiple versions of fastener 2220 and fastener 2240 can be placed in various locations in top board 2210 and bottom board 2310, thereby allowing their connections to be locally placed, as compared to being routed a distance to a larger conventional board-to-board connector.

Contacts 2330 and contacts 2350 can instead be formed as solder bumps, while contacts 2230 and contacts 2250 can instead be formed as flat contacts. Some or all of contacts 2230, contacts 2250, contacts 2330, and contacts 2350, can instead be low-profile spring or beam contacts. The spring or beam contacts can be formed of stainless steel, spring steel, or other conductive material. The use of spring contacts can provide a locking feature holding the components of board-to-board connector 2200 in place relative to each other.

Board-to-board connector 2200 can simplify assembly, be reworkable, and enable component replacement. Assembly can be simplified in an embodiment where the top board 2210 is aligned to the bottom board 2310, fastener 2220 and fastener 2240 are passed through first opening 2212 and second opening 2218 in top board and first opening 2312 and second opening 2318 in bottom board 2310, and fastener 2220 and fastener 2240 are screwed into a nut or threaded opening in a board or housing. Rework can be simplified since only the removal of fastener 2220 and fastener 2240 is needed. Replacement of parts in an electronic device can be simplified as well. For example, one of top board 2210 and bottom board 2310 can be part of a replaceable battery assembly. The ability to rework board-to-board connector 2200 can simplify replacement of the battery.

While two fasteners and two boards are shown here, other numbers of boards and fasteners can be used. For example, one, three, or more than three fasteners can be used. Additional flexible circuit boards or printed circuit boards can be added, for example below bottom board 2310. The bottom of bottom board 2310 can include contacts that can form electrical connections with contacts or pads on an additional board below bottom board 2310.

In these and other embodiments of the present invention, the first connector can be one of a receptacle or a plug. The second connector can be the other one of a receptacle or a plug.

These and other embodiments of the present invention can provide board-to-board connectors that are easy to use and connect in an electronic device. This can facilitate and simplify assembly. These features can also facilitate device repair and component replacement by users and other third party.

While embodiments of the present invention can provide a first connector that connects to an internal housing or enclosure portion through a circuit board, these and other embodiments of the present invention can provide a connection to a printed circuit board or other conduit structure that is attached to or otherwise fixed or associated with the internal housing or enclosure portion.

While these and other embodiments of the present invention are well-suited for use in connecting two or more internal housing or enclosure portions together, embodiments of the present invention can provide board-to-board connectors for non-blind connections, or blind connections between other structures, such as printed circuit boards or flexible circuit boards that are not fixed to an internal housing or enclosure portion.

In these and other embodiments of the present invention, signal contacts, power supply contacts, ground contacts, ground shields, and other conductive portions can be formed by stamping, metal-injection molding, machining, micro-machining, 3-D printing, or other manufacturing process. The conductive portions can be formed of stainless steel, steel, copper, copper titanium, phosphor bronze, or other material or combination of materials. They can be plated or coated with nickel, gold, or other material. The nonconductive portions, such as the internal housing and enclosure portions, can be formed using injection or other molding, 3-D printing, machining, or other manufacturing process. The nonconductive portions can be formed of silicon or silicone, rubber, hard rubber, plastic, nylon, liquid-crystal polymers (LCPs), or other nonconductive material or combination of materials.

These and other embodiments of the present invention can provide board-to-board connectors that can be located in various types of devices, such as portable computing devices, tablet computers, desktop computers, laptops, all-in-one computers, cell phones, wearable-computing devices, storage devices, portable media players, navigation systems, monitors, power supplies, adapters, remote control devices, audio devices, chargers, and other devices. These high-speed connectors can provide pathways for signals that are compliant with various standards such as Universal Serial Bus (USB), USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A board-to-board connector system comprising:
a first connector comprising:
a housing having a first opening;
a plurality of contacts supported by the housing;
a shield partially around the housing and having a first opening;
a first fastener having an opening and located in the first opening in the housing and the first opening in the shield; and
a second fastener in the first fastener, the first fastener and the second fastener to attach to a substrate; wherein the housing, plurality of contacts, and shield is movable laterally and angularly with respect to the first fastener and the second fastener; and
a second connector comprising:
a housing;
a plurality of contacts supported by the housing; and
a shield partially around the housing; and
a flexible circuit board coupled to the plurality of contacts and the shield of the second connector.

2. The board-to-board connector system of claim 1 wherein the flexible circuit board is flexible to allow the housing, plurality of contacts, and shield to move laterally and angularly with respect to the first fastener and the second fastener when the first connector and the second connector are mated.

3. The board-to-board connector system of claim 2 wherein the first connector is a receptacle and the second connector is a plug.

4. The board-to-board connector system of claim 3 wherein the first fastener is a shoulder screw.

5. The board-to-board connector system of claim 4 wherein the second fastener is a screw.

6. The board-to-board connector system of claim 3 wherein the second fastener is press fit into the first fastener.

7. The board-to-board connector system of claim 3 wherein the plurality of contacts in the receptacle comprise a plurality of signal contacts having a first width and a plurality of power contacts having a second width, the second width greater than the first width.

8. A board-to-board connector comprising:
a first connector comprising:
a housing;
a plurality of contacts supported by the housing;
a shield partially around the housing; and
a first alignment post extending from the housing; and
a second connector comprising:
a housing;
a plurality of contacts supported by the housing;
a shield partially around the housing; and
a first opening in the housing to accept the first alignment post when the first connector and the second connector are mated.

9. The board-to-board connector of claim 8 wherein during mating of the first connector to the second connector, the first alignment post is configured to align the first connector to the second connector before the plurality of contacts of the first connector mate with the plurality of contacts of the second connector.

10. The board-to-board connector of claim 8 wherein the first connector further comprises a second alignment feature and the second connector further comprises a second opening to accept the second alignment feature.

11. The board-to-board connector of claim 10 wherein the second alignment feature comprises an insert.

12. The board-to-board connector of claim 11 wherein the second alignment feature comprises a threaded insert to accept a fastener to secure the first connector to a substrate.

13. The board-to-board connector of claim 12 wherein the housing, the first alignment post is plastic and the threaded insert is metallic.

14. The board-to-board connector of claim 13 wherein during mating of the first connector to the second connector, the first alignment post is configured to align the first connector to the second connector before the plurality of contacts of the first connector mate with the plurality of contacts of the second connector.

15. The board-to-board connector of claim 8 wherein the housing of the second connector comprises a recessed portion around the opening, and wherein the recessed portion is at least partially covered by a portion of the shield of the second connector.

16. A board-to-board connector comprising:
a first board comprising a first opening;
a second board comprising a first opening;
a first fastener having a first head and a first shaft, wherein the first shaft passes through the first opening in the first board and the first opening in the second board;
a first plurality of contacts on a bottom side of the first board and below the first head; and
a second plurality of contacts on a top side of the second board and below the first head, the second plurality of contacts positioned to mate with the first plurality of contacts.

17. The board-to-board connector of claim 16 wherein the first board further comprises a second opening and the second board further comprises a second opening, the board-to-board connector further comprising:
a second fastener having a second head and a second shaft, wherein the second shaft passes through the second opening in the first board and the second opening in the second board;
a third plurality of contacts on a bottom side of the first board and below the second head; and
a fourth plurality of contacts on a top side of the second board and below the second head, the third plurality of contacts positioned to mate with the fourth plurality of contacts.

18. The board-to-board connector of claim 17 wherein the first shaft of the first fastener is screwed into a first hole in a housing and the second shaft of the second fastener is screwed into a second hole in the housing.

19. The board-to-board connector of claim 18 wherein the first shaft of the first fastener is screwed into a first nut in the first hole in the housing and the second shaft of the second fastener is screwed into a second nut in the second hole in the housing.

20. The board-to-board connector of claim 17 wherein the first board is a first flexible circuit board and the second board is a second flexible circuit board.
